(19) United States
(12) Patent Application Publication
(10) Pub. No.: US 2018/0352167 A1
(43) Pub. Date: Dec. 6, 2018

(54) IMAGE PICKUP APPARATUS, IMAGE PICKUP CONTROL METHOD, AND PROGRAM

(71) Applicant: Sony Corporation, Tokyo (JP)

(72) Inventor: Motoshige Okada, Kanagawa (JP)

(73) Assignee: Sony Corporation, Tokyo (JP)

(21) Appl. No.: 15/746,186

(22) PCT Filed: Feb. 6, 2017
(86) PCT No.: PCT/JP2017/004161

§ 371 Date: Jan. 19, 2018

(30) Foreign Application Priority Data
Feb. 19, 2016 (JP) 2016-029924

(51) Int. Cl. H04N 5/232; G06T 7/521; G06T 7/593

(52) U.S. Cl. CPC H04N 5/232121; H04N 5/23216; G06T 7/521; G06T 2207/10028; H04N 5/232939; G06T 2207/10048; G06T 7/593

(57) ABSTRACT

The present technology relates to an image pickup apparatus, an image pickup control method, and a program that enable focus control to be performed without depending on environmental conditions and optical conditions, for example.

An image pickup apparatus includes: an image pickup device having a predetermined image pickup area; a lens drive unit that drives a focus lens; a storage unit that stores, in a lookup table, a correspondence relationship between distance information with respect to a subject and lens position information of the focus lens; a distance information acquisition unit that acquires distance information with respect to an object existing in the image pickup area; and a control unit that controls the lens drive unit on the basis of the distance information acquired by the distance information acquisition unit and the lookup table. The present technology is applicable to, for example, an image pickup apparatus that performs focus control.

### TECHNICAL FIELD

The present technology relates to an image pickup apparatus, an image pickup control method, and a program, more particularly, to an image pickup apparatus, an image pickup control method, and a program that enable focus control to be performed without depending on environmental conditions and optical conditions, for example.

### BACKGROUND ART

As an autofocus system in an image pickup apparatus, there are a contrast system and a phase difference system. The contrast system involves a method of detecting a contrast change while shifting a lens position of a focus lens, and setting a position at which the contrast becomes maximum as an in-focus position. The phase difference system involves a method of determining an in-focus position from a distance measurement result based on a triangulation method using a phase difference sensor different from an image sensor.

In the contrast system and the phase difference system, it is difficult to perform autofocus at a dark place or with a lens having a shallow depth of field. In this regard, for example, there is proposed an image pickup apparatus capable of acquiring an image having a large depth of field by performing blur removal processing for removing a blur of image information (see, for example, Patent Literature 1).

### CITATION LIST

### Patent Literature

Patent Literature 1: Japanese Patent Application Laid-open No. 2014-138290

### DISCLOSURE OF INVENTION

### Technical Problem

As described above, focus control that does not depend on environmental conditions such as a dark place and optical conditions such as a lens having a shallow depth of field is being desired, but such a demand is not sufficiently satisfied.

The present technology has been made in view of the circumstances as described above and aims at enabling focus control to be performed without depending on environmental conditions and optical conditions, for example.

### Solution to Problem

An image pickup apparatus according to a first aspect of the present technology includes: an image pickup device having a predetermined image pickup area; a lens drive unit that drives a focus lens; a storage unit that stores, in a lookup table, a correspondence relationship between distance information with respect to a subject and lens position information of the focus lens; a distance information acquisition unit that acquires distance information with respect to an object existing in the image pickup area; and a control unit that controls the lens drive unit on the basis of the distance information acquired by the distance information acquisition unit and the lookup table.

An image pickup control method according to a first aspect of the present technology is a method carried out by an image pickup apparatus including an image pickup device having a predetermined image pickup area, a lens drive unit that drives a focus lens, and a storage unit that stores, in a lookup table, a correspondence relationship between distance information with respect to a subject and lens position information of the focus lens, the method including: acquiring distance information with respect to an object existing in the image pickup area; and controlling the lens drive unit on the basis of the acquired distance information and the lookup table.

A program according to a first aspect of the present technology is a program that causes a computer of an image pickup apparatus including an image pickup device having a predetermined image pickup area and a storage unit that stores, in a lookup table, a correspondence relationship between distance information with respect to a subject and lens position information of a focus lens, to execute processing including: acquiring distance information with respect to an object existing in the image pickup area; and controlling a lens position of the focus lens on the basis of the acquired distance information and the lookup table.

In the first aspect of the present technology, in the image pickup apparatus including the image pickup device having the predetermined image pickup area and the storage unit that stores, in the lookup table, the correspondence relationship between distance information with respect to a subject and lens position information of the focus lens, the distance information with respect to an object existing in the image pickup area is acquired, and the lens position of the focus lens is controlled on the basis of the acquired distance information and the lookup table.

An image pickup apparatus according to a second aspect of the present technology includes: an image pickup device having a predetermined image pickup area; a lens drive unit that drives a focus lens; a storage unit that stores, in a lookup table, a correspondence relationship between distance information with respect to a subject and lens position information of the focus lens; a lens position control unit that controls the lens drive unit on the basis of the lookup table; a distance information acquisition unit that acquires distance information with respect to an object existing in the image pickup area; and an image pickup control unit that executes control related to image pickup on the basis of the distance information acquired by the distance information acquisition unit.

In the second aspect of the present technology, the lens drive unit is controlled on the basis of the lookup table that stores the correspondence relationship between the distance information with respect to the subject and the lens position information of the focus lens, the distance information with respect to the object existing in the image pickup area is acquired, and the control related to image pickup is executed on the basis of the acquired distance information.

It should be noted that the program can be provided by being transmitted via a transmission medium or being recorded onto a recording medium.

The image pickup apparatus may be an independent apparatus or an internal block configuring a single apparatus.

### Advantageous Effects of Invention

According to the first and second aspects of the present technology, focus control can be performed without depending on environment conditions and optical conditions, for example.

It should be noted that the effects described herein are not necessarily limited, and any effect described in the present disclosure may be obtained.

### BRIEF DESCRIPTION OF DRAWINGS

FIG. 1 A block diagram showing a configuration example of a first embodiment of an image pickup apparatus to which the present technology is applied.

FIG. 2 An outer appearance view showing an arrangement of a distance measurement sensor and an image pickup sensor.

FIG. 3 A detailed block diagram of the image pickup apparatus shown in FIG. 1.

FIGS. 4 Diagrams showing examples of a captured image and a depth map.

FIG. 5 A diagram for explaining a first photographing mode.

FIG. 6 A flowchart for explaining first photographing processing.

FIG. 7 A flowchart for explaining second photographing processing.

FIG. 8 A diagram for explaining a third photographing mode.

FIG. 9 A flowchart for explaining third photographing processing.

FIG. 10 A diagram for explaining a distance information input method in the third photographing mode.

FIG. 11 A flowchart for explaining fourth photographing processing.

FIG. 12 A flowchart for explaining LUT generation processing.

FIG. 13 A block diagram showing a specific configuration example of a second embodiment of an image pickup apparatus to which the present technology is applied.

FIG. 14 A block diagram showing a configuration example of a third embodiment of an image pickup apparatus to which the present technology is applied.

FIG. 15 An outer appearance view showing an arrangement of a distance measurement sensor and an image pickup sensor.

FIG. 16 A detailed block diagram of the image pickup apparatus shown in FIG. 14.

FIGS. 17 Cross-sectional diagrams showing a first configuration example in a case where the image pickup apparatus is a mirrorless digital camera.

FIGS. 18 Cross-sectional diagrams showing a second configuration example in the case where the image pickup apparatus is a mirrorless digital camera.

FIGS. 19 Cross-sectional diagrams showing a configuration example in a case where the image pickup apparatus is a single-lens-reflex digital camera.

FIG. 20 A cross-sectional diagram showing an arrangement example of the distance measurement sensor and the image pickup sensor.

FIG. 21 A block diagram showing a configuration example of an embodiment of a computer to which the present technology is applied.

FIG. 22 A block diagram showing a schematic configuration example of a vehicle control system.

FIG. 23 An explanatory diagram showing an example of setting positions of outside-of-vehicle information detection unit and an image pickup unit.

### MODES FOR CARRYING OUT THE INVENTION

Hereinafter, configurations for embodying the present technology (hereinafter, referred to as embodiments) will be described. It should be noted that descriptions will be given in the following order.

1. First embodiment (configuration example of active-type distance measurement system)

2. Second embodiment (configuration example including plurality of LUTs)

3. Third embodiment (configuration example of passive-type distance measurement system)

4. Configuration example of digital camera

5. Explanation on computer to which present technology is applied

6. Application example

### 1. First Embodiment

<Configuration Example of Image Pickup Apparatus>

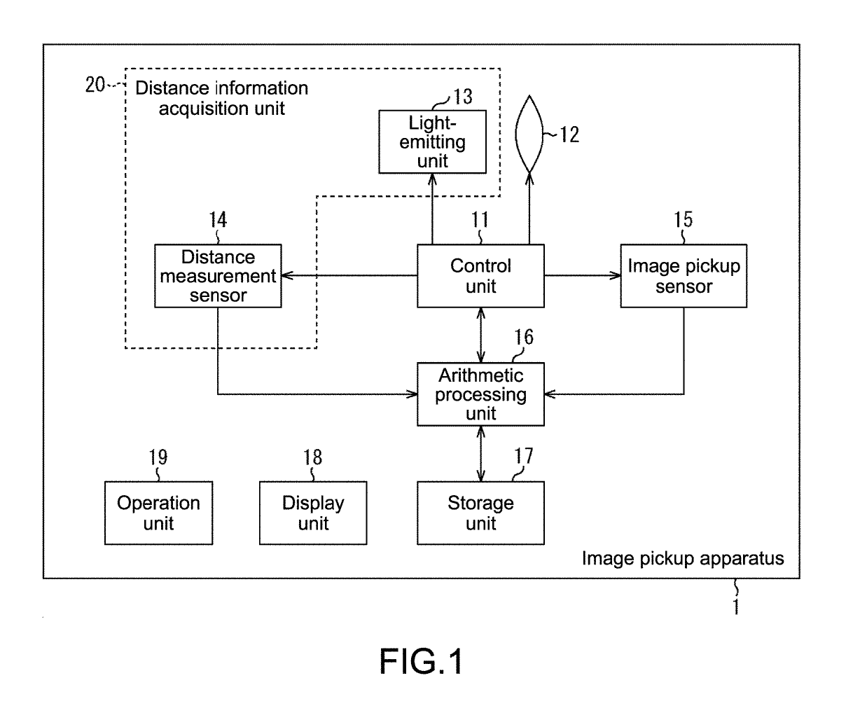

FIG. 1 is a block diagram showing a configuration example of a first embodiment of an image pickup apparatus to which the present technology is applied.

An image pickup apparatus 1 shown in FIG. 1 includes, for example, a single-lens-reflex digital camera, a mirrorless digital camera, an interchangeable-lens-type digital camera, a compact digital camera, a digital video camera, and the like. Further, the image pickup apparatus 1 may be an electronic apparatus such as a smartphone, that includes an image pickup function as a part of its functions.

The image pickup apparatus 1 includes a control unit 11, an optical system 12, a light-emitting unit 13, a distance measurement sensor 14, an image pickup sensor 15, an arithmetic processing unit 16, a storage unit 17, a display unit 18, and an operation unit 19.

The control unit 11 includes, for example, an arithmetic processing unit such as a CPU (Central Processing Unit) and an MPU (Micro Processing Unit), peripheral circuits, and the like, and reads out and executes a predetermined control program recorded in the storage unit 17, to thus control overall operations of the image pickup apparatus 1.

For example, the control unit 11 controls lens positions of various lenses configuring the optical system 12, such as a focus lens, a zoom lens, and a camera shake correction lens, and controls on/off of light emission by the light-emitting unit 13. Alternatively, the control unit 11 controls an image pickup operation of the image pickup sensor 15 and the distance measurement sensor 14 and causes the arithmetic processing unit 16 to execute predetermined arithmetic processing.

The optical system 12 is constituted of various lenses such as a focus lens, a zoom lens, and a camera shake correction lens, for example, and is moved to a predetermined position under control of the control unit 11.

The light-emitting unit 13 includes, for example, an LED (Light Emitting Diode) light source that emits IR light (infrared light), and turns on/off emission of IR light under control of the control unit 11. The light-emitting unit 13 is capable of emitting IR light by a predetermined light-emitting pattern (on/off repeating pattern).

The distance measurement sensor 14 functions as a light reception unit that receives the IR light emitted from the light-emitting unit 13 and measures a distance to a subject using a ToF (Time of Flight) system, for example. In the ToF system, an elapsed time up to when IR light emitted from the light-emitting unit 13 is reflected back by a surface of the subject is measured, and the distance to the subject is measured on the basis of the elapsed time. The distance measurement sensor 14 that uses the ToF system is capable of generating distance information at high speed (in short cycle) and is also capable of generating distance information even at a dark place irrespective of peripheral brightness since it uses IR light.

For example, the distance measurement sensor 14 is constituted of an image pickup device (image sensor) in which respective pixels forming a photodiode are arranged two-dimensionally, and by measuring the elapsed time before IR light is received for each pixel, a distance of not only one point of a subject but also various parts can be measured. As a method of measuring the elapsed time described above, there are a method of pulse-irradiating IR light and directly measuring a time before the light is reflected back by a surface of a subject, a method of modulating IR light and calculating on the basis of a phase difference between a phase of light during irradiation and a phase of light that has been reflected back, and the like.

The distance information measured by the distance measurement sensor 14 is supplied to the arithmetic processing unit 16.

The light-emitting unit 13 and the distance measurement sensor 14 constitute a distance information acquisition unit 20 that acquires distance information with respect to a subject included in an image captured by the image pickup sensor 15. It should be noted that a method of acquiring distance information with respect to a subject, that is carried out by the distance information acquisition unit 20, is not limited to the ToF system. For example, distance information with respect to a subject may be acquired using a structure light method or the like. The structure light method is a method of estimating a distance to an object by projecting a light pattern of a special design onto a surface of the object and analyzing a deformation of the projected pattern.

Further, it is also possible to generate an IR image on the basis of a light amount of IR light received by the distance measurement sensor 14 and use a deviation amount between IR images updated at a predetermined cycle as a correction amount in a camera shake correction.

The image pickup sensor 15 is constituted of an image pickup device including a two-dimensional image pickup area, such as a CCD (Charge Coupled Device) sensor and a CMOS (Complementary Mental Oxide Semiconductor) sensor, for example. Under control of the control unit 11, the image pickup sensor 15 captures an image of a subject, generates image data, and supplies the image data to the arithmetic processing unit 16.

The arithmetic processing unit 16 calculates a distance to a subject in a predetermined focus target area in the image supplied from the image pickup sensor 15 using the distance information supplied from the distance measurement sensor 14. A correspondence relationship between a pixel position of each pixel of the image pickup sensor 15 and a pixel position of each pixel of the distance measurement sensor 14, that is, a positional relationship between the image pickup sensor 15 and the distance measurement sensor 14 is corrected in advance and stored in the storage unit 17.

Further, the arithmetic processing unit 16 references a LUT (lookup table) that is stored in the storage unit 17 and stores a correspondence relationship between the distance information to a subject and a lens control value, acquires a lens control value corresponding to the distance to a subject in the focus target area, and supplies it to the control unit 11. The control unit 11 drives a focus lens of the optical system 12 using the lens control value supplied from the arithmetic processing unit 16.

Furthermore, the arithmetic processing unit 16 executes demosaic processing on a RAW image supplied from the image pickup sensor 15 and further executes processing of converting it into image data in a predetermined file format and recording the image data in the storage unit 17, and the like.

The storage unit 17 is constituted of a storage medium such as a semiconductor memory, for example, and stores a LUT that stores the correspondence relationship between the distance information to a subject and the lens control value. Further, the storage unit 17 stores a captured image (hereinafter, referred to as recording image) captured by the image pickup sensor 15 at a timing a shutter operation is performed. Further, the storage unit 17 also stores a program executed by the control unit 11, calibration information indicating the positional relationship between the image pickup sensor 15 and the distance measurement sensor 14, and the like.

The display unit 18 is constituted of a flat-screen display such as an LCD (Liquid Crystal Display) display and an organic EL (Electro Luminescence) display, and displays an image (moving image or still image) captured by the image pickup sensor 15. Further, the display unit 18 also displays an AF window expressing the focus target area, and the like. The display unit 18 is capable of performing display of a live view image that displays an image captured by the image pickup sensor 15 in real time, display of a recording image, and the like.

The operation unit 19 includes, for example, a hardware key such as a shutter button and a software key that uses a touch panel laminated on the display unit 18, receives a predetermined operation performed by a user, and supplies an operation signal thereof to the control unit 11. For example, the user touches a predetermined position of a captured image displayed on the display unit 18, and the touch panel as the operation unit 19 detects a touch position of the user. Accordingly, the focus target area in the captured image is specified and supplied to the control unit 11.

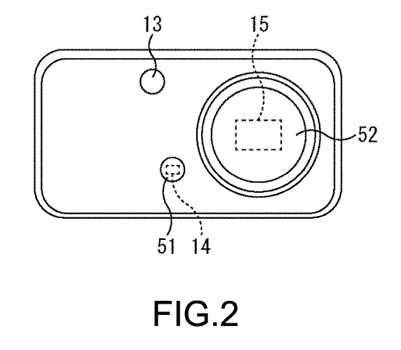

FIG. 2 is an outer appearance view showing an arrangement of the distance measurement sensor 14 and the image pickup sensor 15 in a case where the image pickup apparatus 1 is constituted of a smartphone.

In FIG. 2, in the smartphone as the image pickup apparatus 1, the light-emitting unit 13, the distance measurement sensor 14, and the image pickup sensor 15 are arranged on a surface opposite to a surface on which the display unit 18 (not shown in FIG. 2) is arranged. An upper surface of the distance measurement sensor 14 is covered by a cover glass 51, and an upper surface of the image pickup sensor 15 is also covered by a cover glass 52.

The distance measurement sensor 14 and the image pickup sensor 15 do not need to have the same optical axis as shown in FIG. 2 and may have different optical systems. Further, although the distance measurement sensor 14 and the image pickup sensor 15 are arranged on the same plane in the example shown in FIG. 2, the distance measurement sensor 14 and the image pickup sensor 15 do not need to be arranged on the same plane. In other words, the distance measurement sensor 14 and the image pickup sensor 15 can be arranged at different positions in both a planar direction and an optical axis direction, and a mutual positional relationship is stored in advance in the storage unit 17 as calibration information.

In addition to focus control using a contrast system, the image pickup apparatus 1 configured as described above can use the LUT that stores the correspondence relationship between the distance information with respect to a subject and the lens control value to perform focus control for moving the focus lens to a lens position corresponding to the distance information acquired by the distance measurement sensor 14 (hereinafter, referred to as LUT focus control).

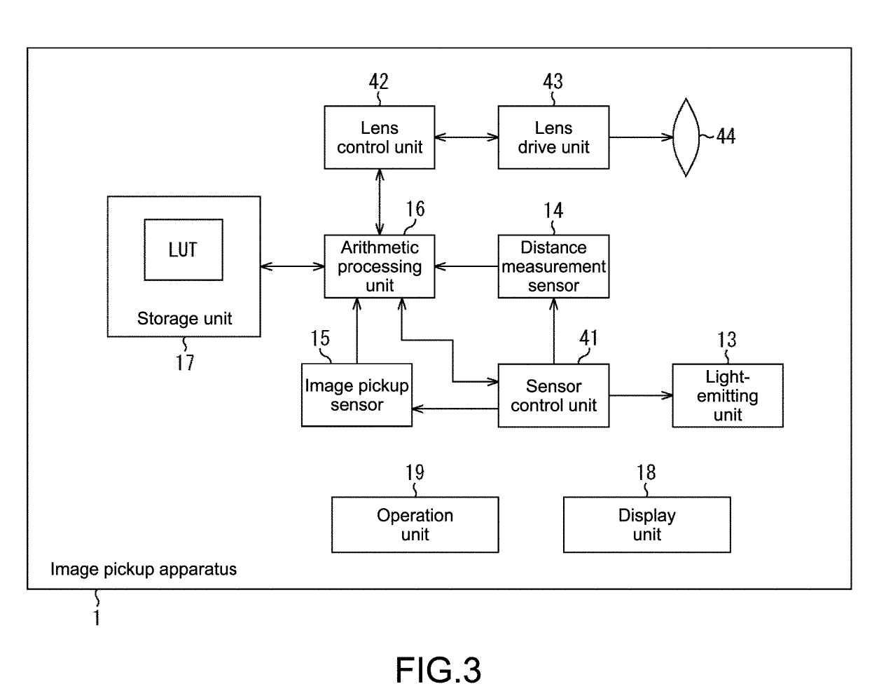

In this regard, the LUT focus control will be described next in detail with reference to FIG. 3.

<Detailed Block Diagram>

FIG. 3 is a detailed block diagram of the image pickup apparatus 1 that is related to the LUT focus control.

It should be noted that in FIG. 3, parts corresponding to those of FIG. 1 are denoted by the same reference numerals, and descriptions on those parts will be omitted as appropriate.

In FIG. 3, the control unit 11 shown in FIG. 1 is divided into a sensor control unit 41, a lens control unit 42, and a lens drive unit 43, and a focus lens 44 as a part of the optical system 12 is illustrated. The sensor control unit 41 and the lens control unit 42 share information that they respectively possess.

The sensor control unit 41 controls on/off of light emission by the light-emitting unit 13 and also controls reception of IR light by the distance measurement sensor 14. Further, the sensor control unit 41 controls the image pickup sensor 15 to capture an image at a predetermined frame rate and causes the image captured by the image pickup sensor 15 to be displayed on the display unit 18 as a preview image, and also causes the storage unit 17 to store a recording image generated at a timing a shutter operation is performed.

The sensor control unit 41 controls the light-emitting unit 13, the distance measurement sensor 14, and the image pickup sensor 15 such that a frame rate at which the distance measurement sensor 14 receives IR light and generates distance information becomes equal to or larger than the frame rate at which the image pickup sensor 15 captures an image. As a result, a time difference generated between a focus operation (lens movement operation) based on distance information and an image pickup timing can be reduced. In a case where the frame rate at which the image pickup sensor 15 captures an image and the frame rate at which the distance measurement sensor 14 generates distance information are the same, the sensor control unit 41 causes an operation to be performed such that a timing after an elapse of a predetermined time since the distance information generation timing becomes an image pickup timing and performs control so that a time difference between the distance information generation timing and the image pickup timing becomes as short as possible.

The arithmetic processing unit 16 acquires a distance to a subject in a focus target area set by the user on the preview image displayed on the display unit 18 from the distance information supplied from the distance measurement sensor 14. Then, the arithmetic processing unit 16 references the LUT stored in the storage unit 17, determines a lens control value corresponding to the distance to the subject, and supplies it to the lens control unit 42.

The storage unit 17 stores the LUT that stores the correspondence relationship between the distance information to the subject and the lens control value. Here, the lens control value is a control value for moving the focus lens 44 to a predetermined position in the optical axis direction and is information (lens position information) corresponding to the lens position of the focus lens 44. Moreover, in addition to the distance itself, the distance information stored in association with the lens control value may be a bit value corresponding to the distance (e.g., depth map value) or the like, and only needs to be information indicating a distance.

The lens control unit 42 controls the lens drive unit 43 for the focus control using the contrast system and the LUT focus control. Specifically, the lens control unit 42 acquires (lens control value corresponding to) a current lens position of the focus lens 44 from the lens drive unit 43 and supplies an instruction to move the focus lens 44 to a predetermined position to the lens drive unit 43. In the LUT focus control, the lens control unit 42 acquires the lens control value determined on the basis of the LUT from the arithmetic processing unit 16 and supplies the lens control value to the lens drive unit 43 so as to drive the lens drive unit 43.

The lens drive unit 43 drives the focus lens 44 so as to become the lens control value supplied from the lens control unit 42. The focus lens 44 is constituted of one or more lenses.

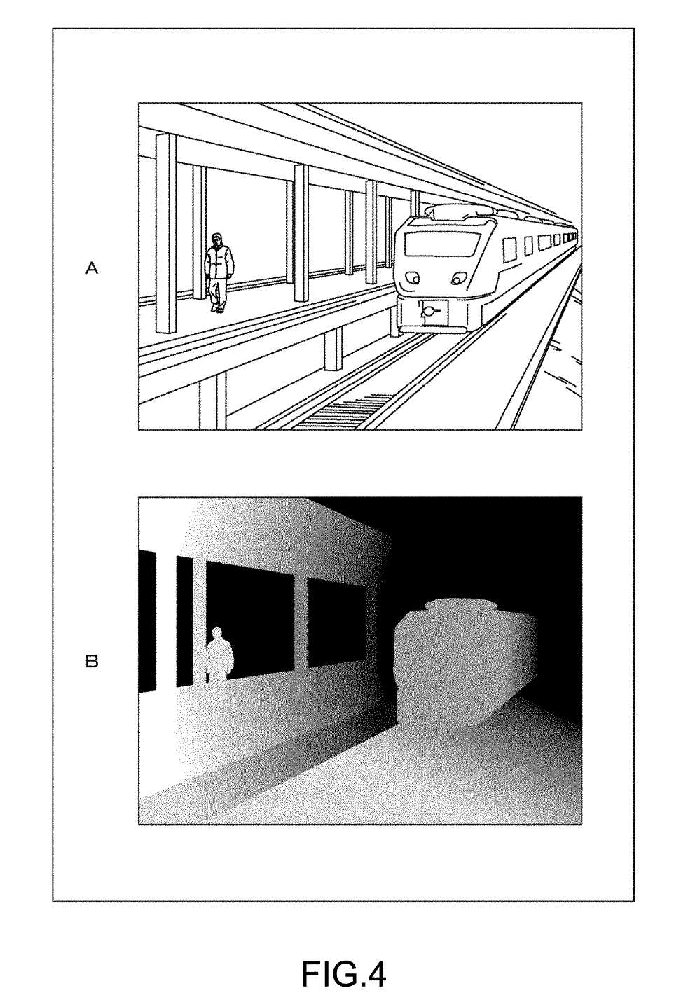

FIG. 4A shows an example of a captured image obtained by the image pickup sensor 15.

FIG. 4B shows an example of a depth map in which distance information measured by the distance measurement sensor 14 with respect to a subject in the captured image shown in FIG. 4A is expressed in gray scale such that the subject takes a darker value as the distance increases.

The control unit 11 can cause the display unit 18 to display the captured image as shown in FIG. 4A, that is obtained by the image pickup sensor 15, as a preview image or a recording image, for example, and can also cause the display unit 18 to display the depth map as shown in FIG. 4B, that is based on the distance information measured by the distance measurement sensor 14.

<First Photographing Mode>

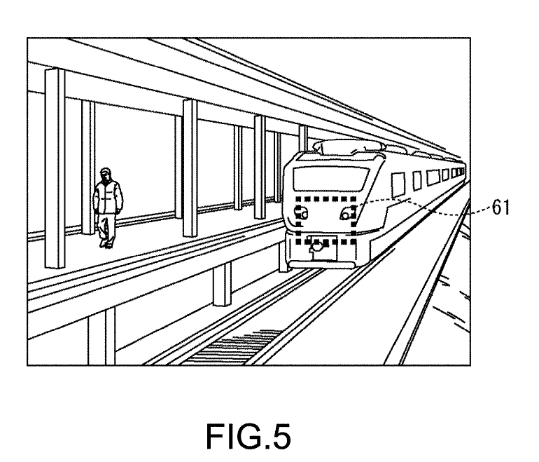

Next, a first photographing mode of the image pickup apparatus 1 will be described with reference to FIG. 5.

On the display unit 18 of the image pickup apparatus 1, an image captured by the image pickup sensor 15 is displayed as a preview image. For example, it is assumed that the image of a train shown in FIG. 4A is captured and displayed on the display unit 18.

The user touches a predetermined position of the preview image displayed on the display unit 18 and designates that position as a focus target area. For example, when the user touches a front portion of the train, the front portion of the train touched by the user is set as the focus target area, and an AF window 61 is displayed as shown in FIG. 5. Then, the lens position of the focus lens 44 is driven so as to be focused on the focus target area.

In this way, the first photographing mode is a photographing mode in which photographing is performed while a focus position (in-focus position) coincides with a predetermined position of a captured image designated by the user.

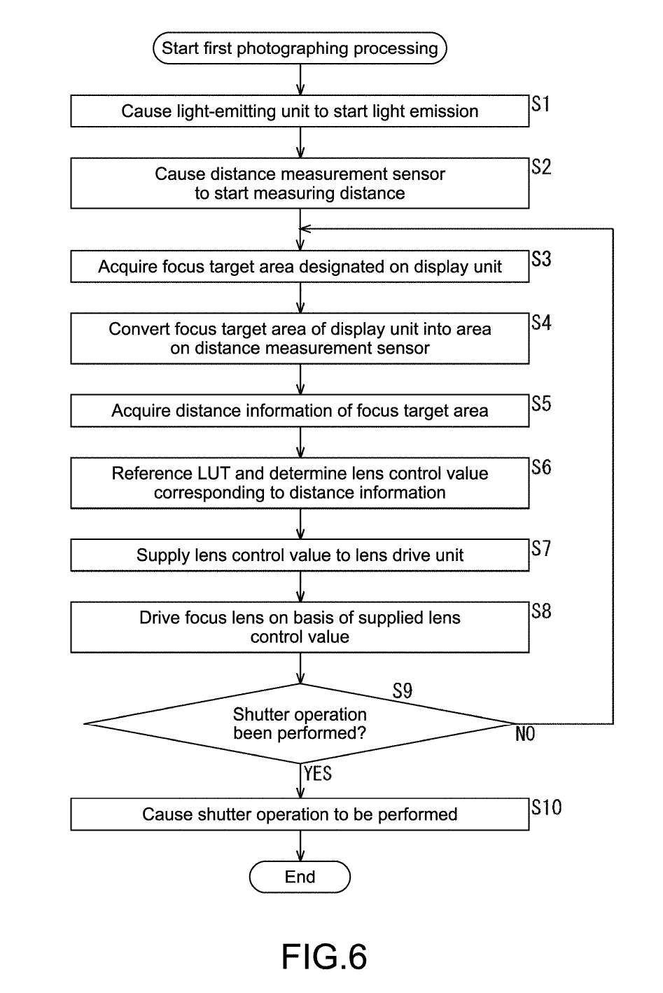

Photographing processing (first photographing processing) in the first photographing mode will be described with reference to the flowchart of FIG. 6.

This first photographing processing is started when an operation mode of the image pickup apparatus 1 is set to the first photographing mode, for example. Alternatively, for example, the first photographing processing may be started when a shutter operation that is made by the user pressing a shutter button halfway (half-pressed state) is performed in a state where the operation mode of the image pickup apparatus 1 is set to the first photographing mode.

In the state where the processing of FIG. 6 is started, it is assumed that the image pickup sensor 15 captures an image at a predetermined frame rate, and a preview image is displayed on the display unit 18.

First, in Step S1, the sensor control unit 41 starts light emission of the light-emitting unit 13. After being instructed by the sensor control unit 41 to start the light-emitting operation, the light-emitting unit 13 continues the light-emitting operation in a predetermined light-emitting pattern until the first photographing processing ends.

In Step S2, the sensor control unit 41 causes the distance measurement sensor 14 to start measuring a distance. The distance measurement sensor 14 repeats an operation of receiving IR light emitted from the light-emitting unit 13, measuring a distance to a subject in pixel units, and supplying the measured distance to the arithmetic processing unit 16 as distance information until the first photographing processing ends. Here, the frame rate at which the distance measurement sensor 14 measures the distance information in units of pixels in a two-dimensional area and supplies it to the arithmetic processing unit 16 is shorter than the frame rate at which the image pickup sensor 15 captures a captured image.

When the user designates a focus target area by, for example, touching a predetermined position of a preview image displayed on the display unit 18, in Step S3, the sensor control unit 41 acquires the focus target area designated on the display unit 18. Specifically, the touch panel laminated on the display unit 18 detects a touch position of the user and supplies it to the sensor control unit 41, and the sensor control unit 41 acquires the touch position of the user as the focus target area.

In Step S4, the sensor control unit 41 supplies information indicating the acquired focus target area to the arithmetic processing unit 16, and the arithmetic processing unit 16 converts the supplied focus target area of the display unit 18 into an area on the distance measurement sensor 14. In other words, while the user has designated a predetermined position of the preview image displayed on the display unit 18 as the focus target area, since the distance measurement sensor 14 and the image pickup sensor 15 are attached at different positions in the apparatus, the position of the focus target area on the display unit 18 is converted into a position of a focus target area on the distance measurement sensor 14 on the basis of the positional relationship between the image pickup sensor 15 and the distance measurement sensor 14, that is stored in the storage unit 17 as calibration information.

In Step S5, the arithmetic processing unit 16 acquires distance information of the focus target area designated by the user from the distance information supplied from the distance measurement sensor 14.

In Step S6, the arithmetic processing unit 16 references a LUT stored in the storage unit 17, determines a lens control value corresponding to the distance information of the focus target area, and supplies the lens control value to the lens control unit 42.

In Step S7, the lens control unit 42 supplies the lens control value supplied from the arithmetic processing unit 16 to the lens drive unit 43.

In Step S8, the lens drive unit 43 drives the focus lens 44 on the basis of the lens control value supplied from the lens control unit 42. As a result, the focus lens 44 is moved to (position of) the lens control value supplied from the lens control unit 42.

In Step S9, the sensor control unit 41 determines whether a shutter operation has been performed. For example, in a case where the image pickup apparatus 1 is a digital camera, it is judged, as the shutter operation, whether the shutter button has been switched from a half-pressed state to a fully-pressed state. For example, in a case where the image pickup apparatus 1 is a smartphone or the like, it is judged whether an operation of tapping the display unit 18 displaying a live view image has been performed.

In a case where it is judged in Step S9 that the shutter operation is not performed, the processing returns to Step S3, and the processing of Steps S3 to S9 described above, that is, the control to drive the focus lens 44 so as to be focused on the subject in the focus target area on the basis of the distance information of the focus target area and the LUT, is repeated.

Then, in a case where it is judged in Step S9 that the shutter operation has been performed, the processing advances to Step S10, and the sensor control unit 41 causes a shutter operation to be performed. In other words, the sensor control unit 41 causes the image captured by the image pickup sensor 15 at a timing the shutter operation is performed to be stored in the storage unit 17 as a recording image, and ends the processing.

As described above, according to the first photographing processing, the lens control value corresponding to the distance information of the focus target area designated by the user is acquired from the LUT stored in the storage unit 17, and the focus lens 44 is controlled to be focused on the subject in the focus target area on the basis of the acquired lens control value.

By using IR light as a light source of the light-emitting unit 13 and measuring the distance to a subject by the distance measurement sensor 14 using the ToF system, distance information can be acquired at high speed even at a dark place, for example, regardless of peripheral brightness.

Since the LUT focus control does not use a phase difference or contrast, it is possible to perform focus even when there is no image in an image captured by the image pickup sensor 15. In addition, it is possible to perform focus even with a focus lens having an extremely-shallow depth of field or at a dark place. Therefore, according to the LUT focus control of the present technology, it is possible to perform focus control without depending on environmental conditions and optical conditions.

<Second Photographing Mode>

Next, a second photographing mode of the image pickup apparatus 1 will be described.

In the second photographing mode, the image pickup apparatus 1 uses a distance measurement function of the distance information acquisition unit 20 to carry out processing of identifying an object in a captured image and causing focus to follow the identified object.

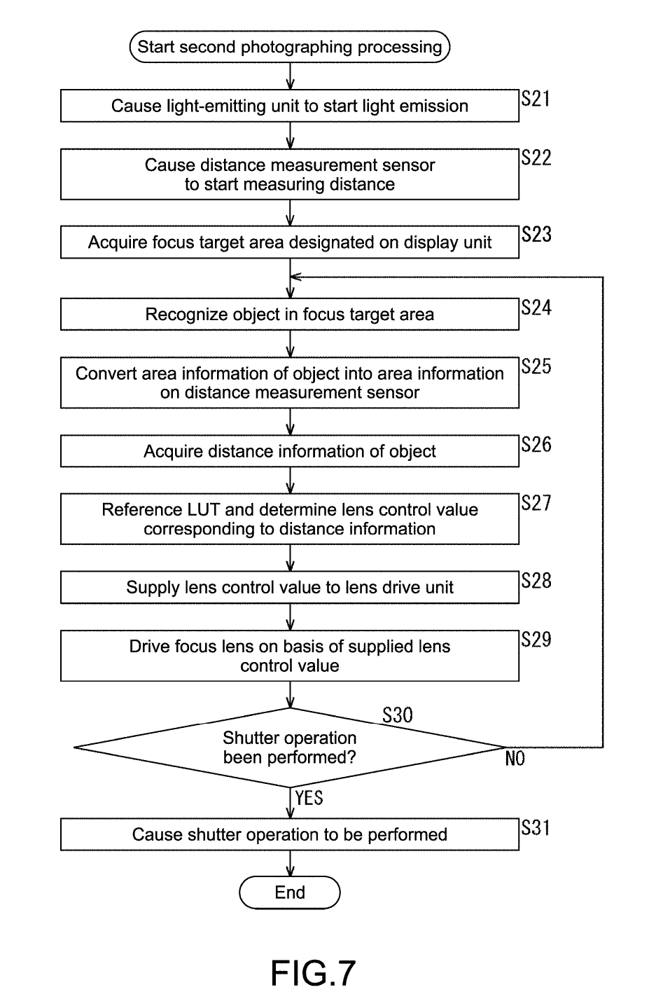

With reference to the flowchart of FIG. 7, photographing processing in the second photographing mode (second photographing processing) will be described. This second photographing processing is started when the operation mode is set to the second photographing mode, for example.

Since the processing of Steps S21 to S23 in FIG. 7 is the same as the processing of Steps S1 to S3 in FIG. 6, descriptions thereof will be omitted.

In Step S24, the sensor control unit 41 supplies information indicating the acquired focus target area to the arithmetic processing unit 16, and the arithmetic processing unit 16 recognizes an object existing in the focus target area in the captured image. A publicly-known object detection technology can be used as an object recognition technology. Distance information output by the distance measurement sensor 14 can be used for the object recognition.

In Step S25, the arithmetic processing unit 16 converts area information of the recognized object into area information on the distance measurement sensor 14 on the basis of the positional relationship between the image pickup sensor 15 and the distance measurement sensor 14, that is stored in the storage unit 17.

In Step S26, the arithmetic processing unit 16 acquires distance information corresponding to the area of the object from the distance information supplied from the distance measurement sensor 14, to thus acquire the distance information of the object.

In Step S27, the arithmetic processing unit 16 references the LUT stored in the storage unit 17, determines a lens control value corresponding to the distance information of the object, and supplies the lens control value to the lens control unit 42.

The processing of Steps S28 to S31 in FIG. 7 is the same as the processing of Steps S7 to S10 in FIG. 6.

In other words, in Step S28, the lens control unit 42 supplies the lens control value supplied from the lens control unit 42 to the lens drive unit 43.

In Step S29, the lens drive unit 43 drives the focus lens 44 on the basis of the lens control value supplied from the lens control unit 42.

In Step S30, the sensor control unit 41 judges whether a shutter operation has been performed.

In a case where it is judged in Step S30 that the shutter operation is not performed, the processing returns to Step 24, and the processing of Steps S24 to S30 described above, that is, the control to drive the focus lens 44 so as to be focused on the recognized object on the basis of the distance information of the recognized object and the LUT, is repeated.

Then, in a case where it is judged in Step S30 that the shutter operation has been performed, the processing advances to Step S31, and the sensor control unit 41 causes a shutter operation to be performed, and ends the processing.

As described above, in the second photographing processing, the user designates an object (subject) to be focused on from the preview image displayed on the display unit 18, and the focus control for causing a focus position to follow the designated object is performed.

While the focus target area does not move even when the subject moves in the preview image displayed on the display unit 18 in the first photographing mode described above, when a subject designated as the object moves, the focus target area also moves in the second photographing mode. For example, even in a case of focusing on a specific person in a scene where a large number of people are present as subjects, focus tracking of an object can be performed without prediction using high-speediness of the distance information output by the distance measurement sensor 14 that uses the ToF system and continuity of distance information.

It should be noted that the second photographing processing described above is an example of performing focus tracking within an image pickup range of the image pickup sensor 15. However, for example, in a case where the image pickup apparatus 1 includes a rotation mechanism for pan (rotational movement in lateral direction)/tilt (rotational movement in longitudinal direction) or includes a function of interlocking with a camera platform including the pan/tilt rotation mechanism, it is also possible to perform focus tracking so as not to frame out.

<Third photographing Mode>

Next, a third photographing mode of the image pickup apparatus 1 will be described.

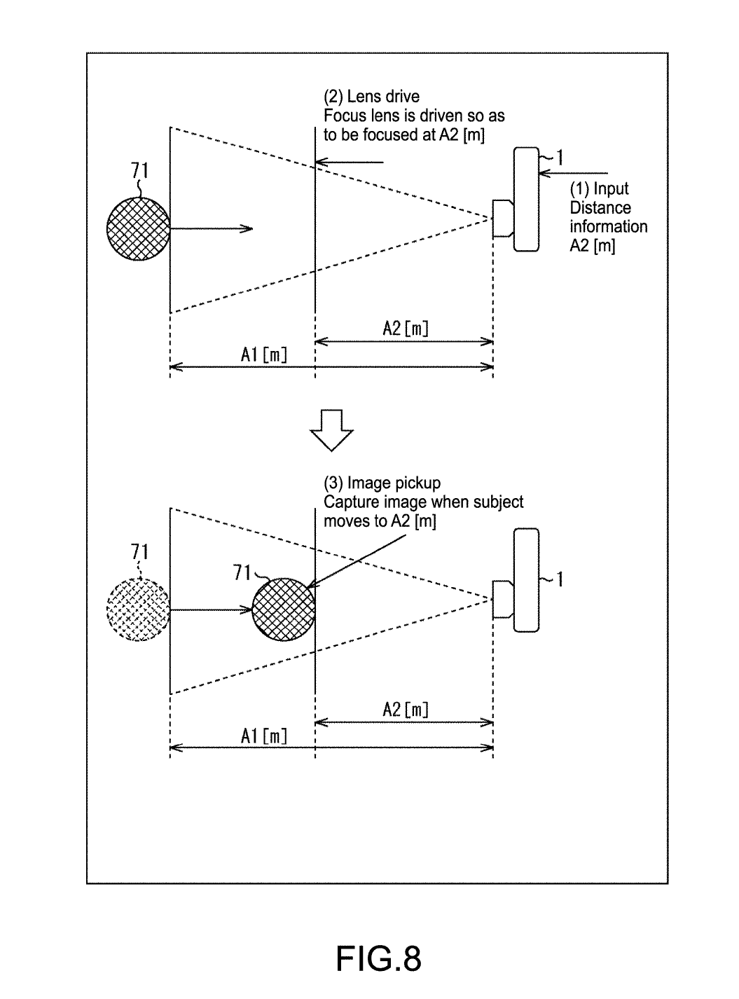

With reference to FIG. 8, the third photographing mode will be described.

As shown in an upper portion of FIG. 8, there is a subject 71 at a distance of A1 (m) in front of the image pickup apparatus 1.

The user operates the operation unit 19 of the image pickup apparatus 1 and inputs distance information A2 (m) as an in-focus position. The sensor control unit 41 of the image pickup apparatus 1 acquires the distance information A2 (m) input by the user, and the lens control unit 42 drives the lens drive unit 43 so as to be focused at the distance A2 (m) in front of the image pickup apparatus 1.

Then, as shown in a lower portion of FIG. 8, when the subject 71 moves to the distance A2 (m) in front of the image pickup apparatus 1, the image pickup apparatus 1 performs a shutter operation to generate a recording image. As a result, an image obtained by capturing the subject 71 by the image pickup sensor 15 at an instant the subject moves to the forward distance A2 (m) is stored in the storage unit 17 as the recording image.

In the LUT focus control, since information in the form of a LUT is used for the focus control, it is also possible to cause the lens to be focused on a space where there is no target object by a numerical value input. In addition, since the in-focus state is already obtained by the numerical value input, a time for focusing is unnecessary, and it becomes possible to easily perform photographing that focuses on a subject that crosses at high speed.

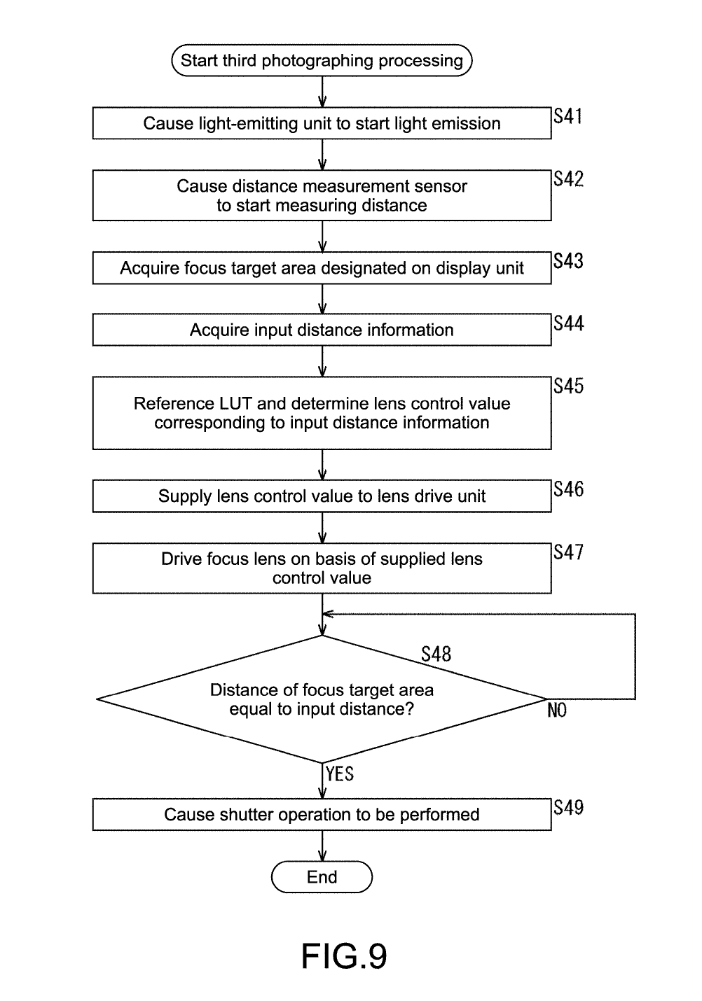

Photographing processing in the third photographing mode (third photographing processing) will be further described with reference to the flowchart of FIG. 9. The third photographing processing is started when the operation mode is set to the third photographing mode, for example.

Since the processing of Steps S41 to S43 in FIG. 9 is the same as the processing of Steps S1 to S3 in FIG. 6, descriptions thereof will be omitted.

In Step S44, the sensor control unit 41 acquires distance information input by the user. For example, the sensor control unit 41 causes an input screen (input dialogue), that prompts a distance to be set as a focus position to be input, to be displayed on the display unit 18, and acquires a numerical value that the user has input as the distance information. The acquired distance information is supplied from the sensor control unit 41 to the arithmetic processing unit 16.

In Step S45, the arithmetic processing unit 16 references the LUT stored in the storage unit 17, determines a lens control value corresponding to the distance information input by the user, and supplies the lens control value to the lens control unit 42.

In Step S46, the lens control unit 42 supplies the lens control value supplied from the arithmetic processing unit 16 to the lens drive unit 43.

In Step S47, the lens drive unit 43 drives the focus lens 44 on the basis of the lens control value supplied from the lens control unit 42. In other words, the focus lens 44 is driven so that the lens position of the focus lens 44 is set at the distance input by the user.

In Step S48, the arithmetic processing unit 16 judges whether a distance of the focus target area is equal to the distance input by the user on the basis of the distance information supplied from the distance measurement sensor 14. Here, when the distance of the focus target area falls within a predetermined range with the distance input by the user being a center value, the arithmetic processing unit 16 judges that the distance of the focus target area is equal to the distance input by the user.

The processing of Step S48 is repeated until it is judged in Step S48 that the distance of the focus target area is equal to the distance input by the user.

Then, in a case where it is judged in Step S48 that the distance of the focus target area is equal to the input distance, the processing advances to Step S49, the arithmetic processing unit 16 notifies the sensor control unit 41 to that effect, and the sensor control unit 41 causes the shutter operation to be performed and ends the processing.

As described above, according to the third photographing processing, in a case where the distance information of the focus target area supplied from the distance measurement sensor 14 becomes distance information corresponding to the distance designated by the user, the shutter operation is executed, and a recording image is generated.

It should be noted that in the third photographing mode, methods other than the method of directly inputting numerical values in the input screen as described above can be used as the method of inputting distance information to be set as a focus position.

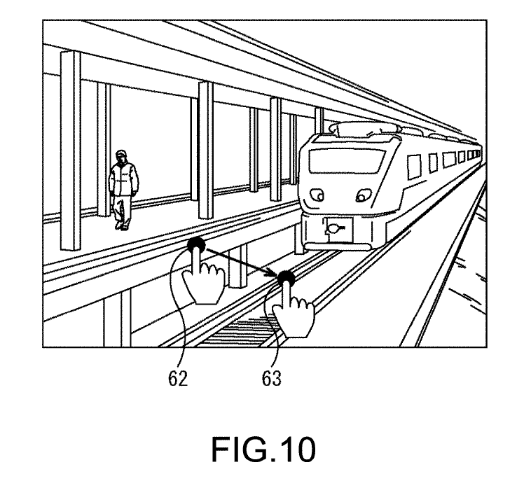

For example, as shown in FIG. 10, the distance information to be set as a focus position may be input by an operation in which the user touches a first position 62 of a preview image displayed on the display unit 18, drags it to a second position 63 (moves without releasing finger from front surface of display unit 18), and thereafter releases the finger touching the front surface of the display unit 18 from the front surface. In this case, the second position 63 where the user has released his/her finger is set as the focus target area so that the AF window 61 is displayed, and the focus lens 44 is driven so as to satisfy the distance information of the first position 62 and is set to standby. Then, in a case where distance information of the second position 63 where the AF window 61 is displayed becomes equal to the distance information of the designated first position 62 on the basis of the distance information supplied from the distance measurement sensor 14, the shutter operation is performed, and a recording image is generated.

In this way, by using the input method of inputting distance information by designating a predetermined position of a preview image instead of inputting a numerical value, it becomes possible for the user to designate a part where the user wishes to set a focus position even when the user does not specifically know a distance thereof as a numerical value.

<Fourth Photographing Mode>

Next, a fourth photographing mode of the image pickup apparatus 1 will be described.

The fourth photographing mode is a continuous photographing mode for generating a plurality of recording images. In the fourth photographing mode, the number of images to be photographed in continuous shooting (e.g., N images), a distance to a subject for photographing a first image (continuous shooting start position), and a distance to the subject for photographing an N-th image (continuous shooting end position) are set.

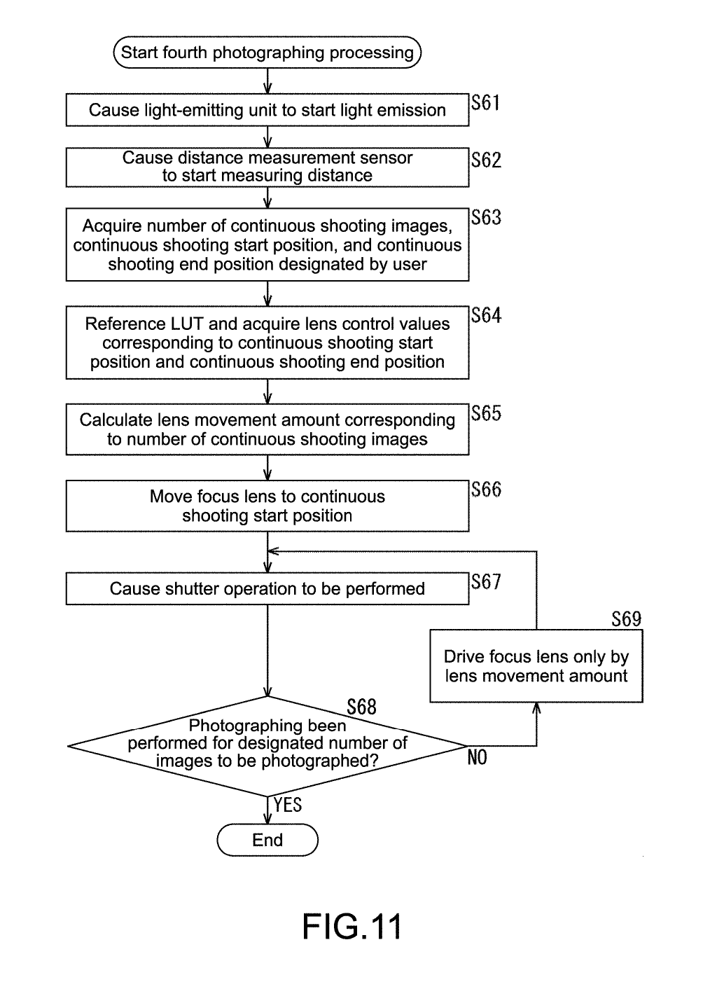

With reference to the flowchart of FIG. 11, photographing processing in the fourth photographing mode (fourth photographing processing) will be further described. The fourth photographing processing is started when the operation mode is set to the fourth photographing mode, for example.

The processing of Steps S61 and S62 in FIG. 11 is the same as the processing of Steps S1 and S2 in FIG. 6.

In other words, the sensor control unit 41 causes the light-emitting unit 13 to start light emission in Step S61, and causes the distance measurement sensor 14 to start measuring a distance in Step S62.

In Step S63, the sensor control unit 41 causes the display unit 18 to display a designation screen for designating the number of continuous shooting images, the continuous shooting start position, and the continuous shooting end position, and acquires numerical values that indicate the number of continuous shooting images, the continuous shooting start position, and the continuous shooting end position that have been designated by the user. The acquired number of continuous shooting images, continuous shooting start position, and continuous shooting end position are supplied from the sensor control unit 41 to the arithmetic processing unit 16. Here, the continuous shooting start position and the continuous shooting end position may be designated by the user performing a manual focus operation and the lens control unit 42 or the like reading a lens position thereof.

In Step S64, the arithmetic processing unit 16 references the LUT stored in the storage unit 17 and acquires lens control values corresponding to the continuous shooting start position and continuous shooting end position designated by the user.

Next, in Step S65, the arithmetic processing unit 16 calculates a lens movement amount corresponding to the number of continuous shooting images designated by the user and supplies the calculation result to the lens control unit 42 together with the lens control values corresponding to the continuous shooting start position and the continuous shooting end position.

In Step S66, the lens control unit 42 supplies the lens control value corresponding to the continuous shooting start position, that has been supplied from the arithmetic processing unit 16, to the lens drive unit 43, and the lens drive unit 43 moves the focus lens 44 to the continuous shooting start position on the basis of the supplied lens control value.

In Step S67, the sensor control unit 41 causes the shutter operation to be performed, creates one recording image, and records it in the storage unit 17.

In Step S68, the sensor control unit 41 judges whether photographing has been performed for the number of shooting images designated by the user.

In a case where it is judged in Step S68 that photographing has not been performed for the designated number of shooting images, the processing advances to Step S69, and the lens control unit 42 drives the focus lens 44 only by the lens movement amount obtained in Step S65 via the lens drive unit 43.

After Step S69, the processing returns to Step S67, and the processing of Steps S67 to S69 is repeated until it is judged that the photographing has been performed for the designated number of shooting images.

Then, in a case where it is judged in Step S68 that the photographing has been performed for the designated number of shooting images, the fourth photographing processing is ended.

According to the fourth photographing processing described above, it is possible to generate a plurality of recording images at high speed by changing a distance to a subject. At this time, since the focus position is set on the basis of the lens control value, it is possible to perform photographing irrespective of whether there is an image in a captured image or a texture.

<LUT Generation Processing>

The LUT stored in the storage unit 17 may be stored in advance at a time of production of the image pickup apparatus 1, for example, but it is also possible for the user him/herself to generate a LUT.

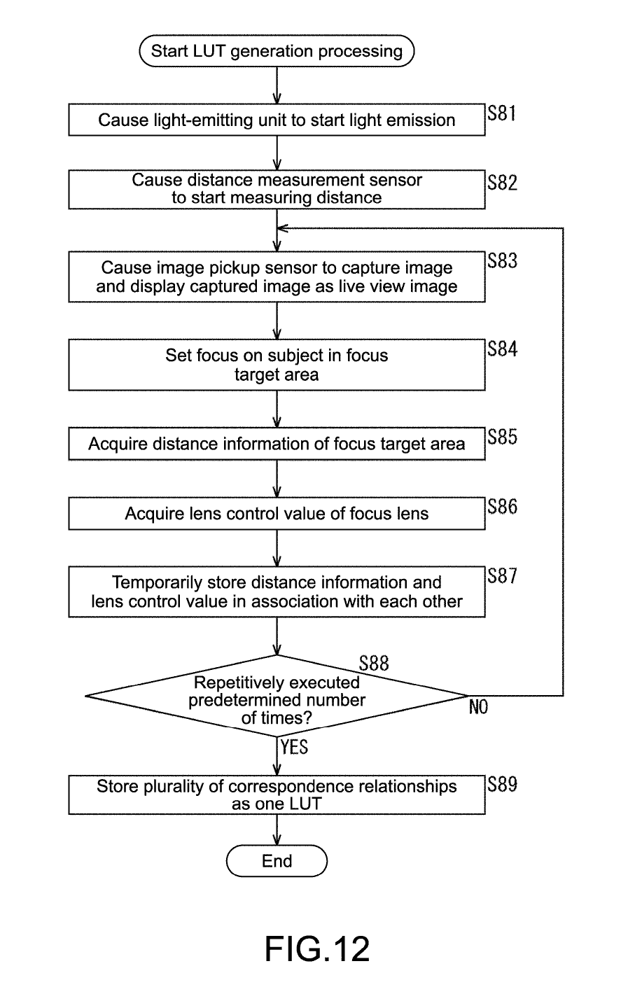

With reference to the flowchart of FIG. 12, LUT generation processing in which the user him/herself generates a LUT will be described. This processing is executed when a start of a LUT generation mode in a setting screen is instructed, for example.

First, in Step S81, the sensor control unit 41 causes the light-emitting unit 13 to start light emission. In Step S82, the sensor control unit 41 causes the distance measurement sensor 14 to start measuring a distance.

In Step S83, the sensor control unit 41 causes the image pickup sensor 15 to capture an image and causes the captured image obtained as a result to be displayed on the display unit 18 as a live view image.

The user designates a focus target area by, for example, touching a predetermined position of the preview image displayed on the display unit 18, and then causes contrast autofocus to be executed.

In response to the user operation, in Step S84, the sensor control unit 41 performs contrast focus control as well as acquire the focus target area designated by the user, to thus set a focus on a subject in the focus target area. It should be noted that the user may move the focus lens 44 such that the focus is set in the focus target area by a manual operation instead of the contrast autofocus.

In Step S85, the arithmetic processing unit 16 acquires distance information of the focus target area designated by the user from the distance information supplied from the distance measurement sensor 14.

In Step S86, the lens control unit 42 acquires a lens control value of the focus lens 44 via the lens drive unit 43 and supplies it to the arithmetic processing unit 16.

In Step S87, the arithmetic processing unit 16 temporarily stores the acquired distance information of the focus target area and the lens control value in the storage unit 17 in association with each other.

In Step S88, the arithmetic processing unit 16 judges whether the processing of Steps S83 to S87 has been repetitively executed a predetermined number of times set in advance. In other words, in Step S88, it is judged whether only a predetermined number of correspondence relationships between the distance information and the lens control value have been temporarily stored in the storage unit 17.

In a case where it is judged in Step S88 that the processing has not been repeated a predetermined number of times yet, the processing returns to Step S83, and the processing of Steps S83 to S87 described above is executed again.

On the other hand, in a case where it is judged in Step S88 that the processing of Steps S83 to S87 has been repetitively executed a predetermined number of times determined in advance, the processing advances to Step S89, and the arithmetic processing unit 16 causes the plurality of correspondence relationships between the distance information and the lens control values, that have been temporarily stored in the storage unit 17 by the repetitively-executed processing of Step S87, to be stored in the storage unit 17 as a single LUT, and ends the processing.

As described above, by the image pickup apparatus 1 executing the LUT generation processing, the user him/herself can create a LUT that stores the correspondence relationship between the distance information with respect to the subject and the lens control value.

Further, it is also possible for the user him/herself to freely change the LUT stored in the storage unit 17 by reading out the LUT stored in the storage unit 17 and overwriting and correcting either one of the distance information and the lens control value by a numerical value input or the like, or replacing it with the distance information or lens control value acquired by the LUT generation processing.

For example, in the auto focus of the LUT focus control, even in a case where a focus deviation due to a lens individual difference or an individual difference of the image pickup apparatus 1 occurs, the focus deviation can be finely adjusted by executing the LUT generation processing and correcting the LUT. Also a correction of a focus deviation caused by an individual lens, like front and rear pins of the lens, and a correction of a focus deviation due to a change with time or the like are possible without having to prepare special equipment.

### 2. Second Embodiment

<Detailed Block Diagram>

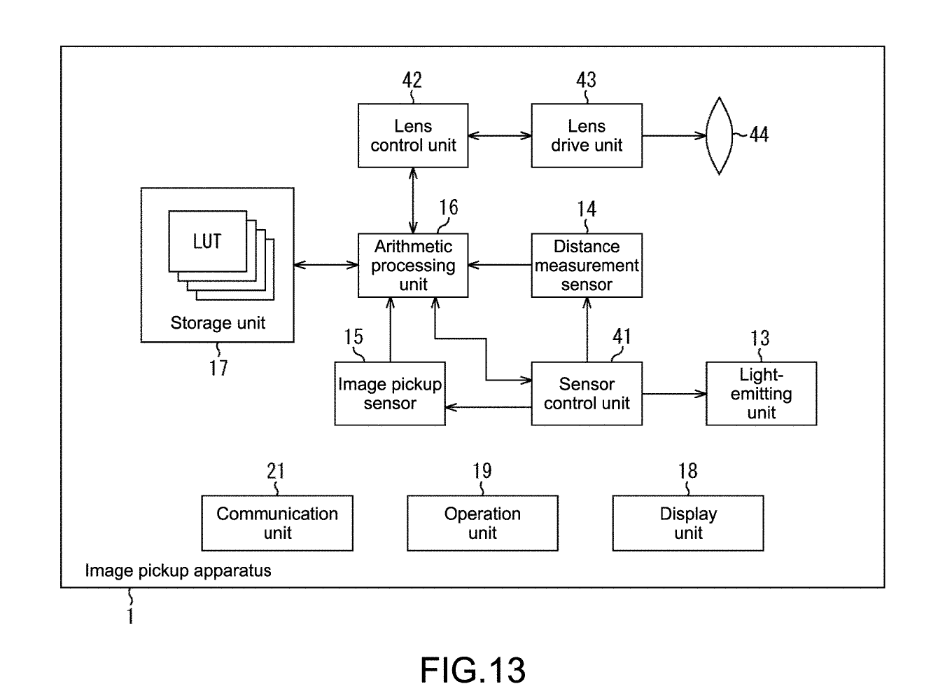

FIG. 13 is a block diagram showing a configuration example of a second embodiment of an image pickup apparatus to which the present technology is applied. The block diagram shown in FIG. 13 corresponds to the detailed block diagram shown in FIG. 3 in the first embodiment.

In the second embodiment, parts corresponding to those of the first embodiment described above are denoted by the same reference numerals, and descriptions thereof will be omitted as appropriate.

Comparing the second embodiment with the first embodiment shown in FIG. 3, a communication unit 21 is newly added in the second embodiment.

The communication unit 21 is constituted of a communication interface such as a USB (Universal Serial Bus) interface and a wireless LAN (Local Area Network), for example, and acquires (receives) data such as a LUT from an external apparatus and transmits a recording image photographed and generated by the image pickup apparatus 1, and the like to the external apparatus.

Further, the second embodiment differs from the first embodiment in that a plurality of LUTs are stored in the storage unit 17 whereas only one LUT is stored in the first embodiment.

One of the plurality of LUTs stored in the storage unit 17 is, for example, a LUT prepared (pre-installed) in advance in the image pickup apparatus 1, and the other one is a LUT generated by the user him/herself by the LUT generation processing described above.

Further, for example, it is also possible to acquire a LUT created by another user, a LUT provided by a download service, or the like via the communication unit 21 and store them in the storage unit 17.

In a case where a plurality of LUTs are stored in the storage unit 17, the user operates the operation unit 19 to select the LUT to be used, and the arithmetic processing unit 16 references the LUT selected by the user to determine a lens control value corresponding to a distance to a subject and supplies it to the lens control unit 42.

Alternatively, in a case where the image pickup apparatus 1 is an interchangeable-lens-type digital camera, the LUT is stored in the storage section 17 for each interchangeable lens (including focus lens 44) to be attached.

In the case where the image pickup apparatus 1 is an interchangeable-lens-type digital camera, at a time the interchangeable lens is attached to a body-side apparatus, a control unit of the body-side apparatus can recognize the attached interchangeable lens by communication with the interchangeable lens. Lens identification information of the interchangeable lens is associated with each LUT in the storage unit 17, and the arithmetic processing unit 16 can automatically (without user instruction) acquire a LUT corresponding to the attached interchangeable lens from the storage unit 17 and use it for the LUT focus control.

### 3. Third Embodiment

<Configuration Example of Image Pickup Apparatus>

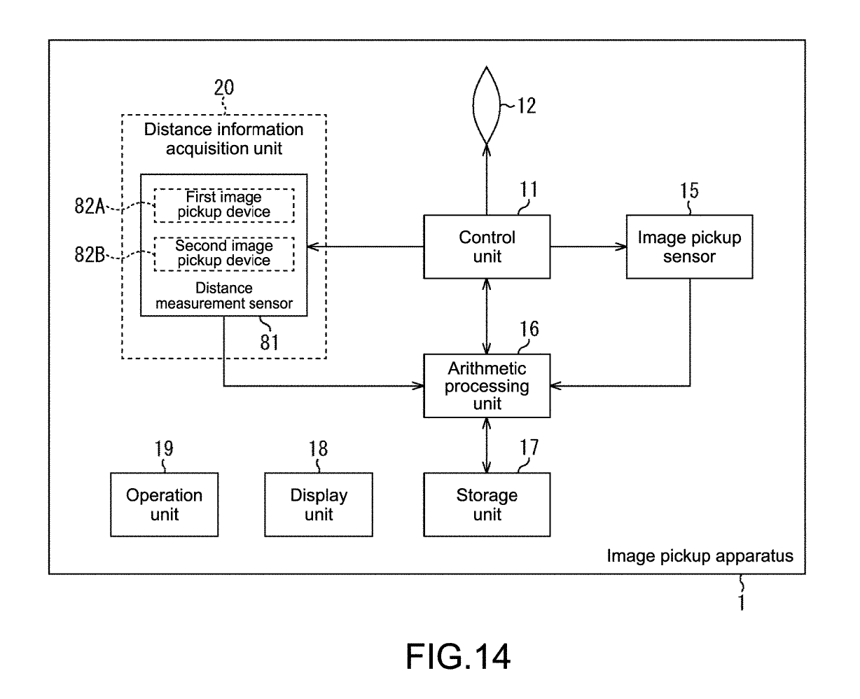

FIG. 14 is a block diagram showing a configuration example of a third embodiment of an image pickup apparatus to which the present technology is applied. The block diagram shown in FIG. 14 corresponds to the block diagram shown in FIG. 1 in the first embodiment.

In the third embodiment, parts corresponding to those of the first embodiment described above are denoted by the same reference numerals, and descriptions thereof will be omitted as appropriate.

Comparing the third embodiment shown in FIG. 14 with the first embodiment, in the third embodiment, the light-emitting unit 13 is omitted in the distance information acquisition unit 20, and a distance measurement sensor 81 is provided in place of the distance measurement sensor 14.

The distance information acquisition unit 20 of the first embodiment described above is a so-called active-type distance measurement system that measures a distance to a subject by the distance measurement sensor 14 receiving light emitted by the light-emitting unit 13.

On the other hand, the distance information acquisition unit 20 of the third embodiment is a so-called passive-type distance measurement system that measures a distance to a subject without requiring the light-emitting unit 13.

The distance measurement sensor 81 includes a first image pickup device 82A and a second image pickup device 82B that receive visible light, and the first image pickup device 82A and the second image pickup device 82B are arranged while being set apart from each other by a predetermined interval in a horizontal direction (lateral direction). The distance measurement sensor 81 measures a distance to a subject from two images captured by the first image pickup device 82A and the second image pickup device 82B using a so-called stereo camera system.

It should be noted that the first image pickup device 82A and the second image pickup device 82B of the distance measurement sensor 81 may be an image pickup device that receives IR light. In this case, the distance to a subject can be measured regardless of peripheral brightness.

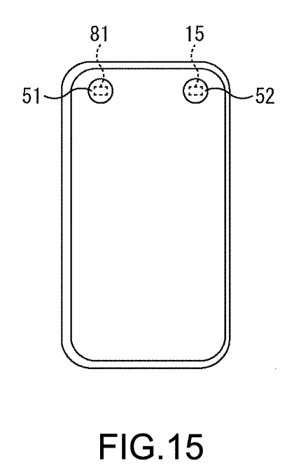

Alternatively, it is also possible to provide only one image pickup device (either one of first image pickup device 82A and second image pickup device 82B) in the distance measurement sensor 81 and arrange the distance measurement sensor 81 a predetermined interval apart from the image pickup sensor 15 in the horizontal direction (lateral direction) as shown in FIG. 15, so that the distance measurement sensor 81 measures the distance to a subject using an image captured by the distance measurement sensor 81 and an image captured by the image pickup sensor 15.

<Detailed Block Diagram>

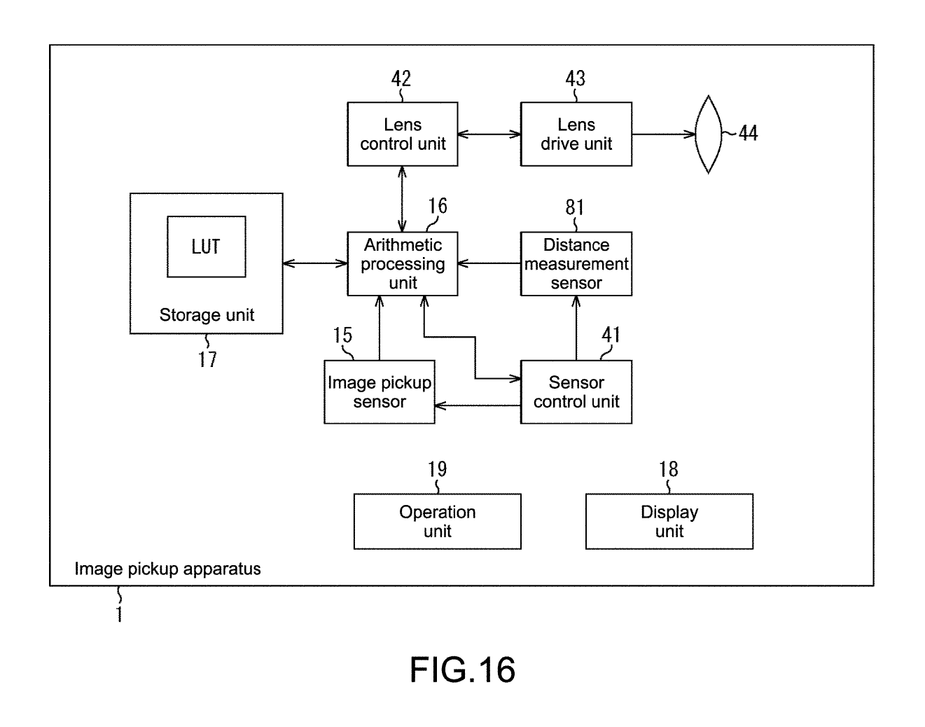

FIG. 16 is a detailed block diagram of the third embodiment. The block diagram shown in FIG. 16 corresponds to the detailed block diagram shown in FIG. 3 in the first embodiment.

Comparing the detailed block diagram of the third embodiment shown in FIG. 16 with the detailed block diagram of the first embodiment shown in FIG. 3, the light-emitting unit 13 is omitted, and the distance measurement sensor 81 is provided in place of the distance measurement sensor 14.

Since the light-emitting unit 13 is omitted in the third embodiment, the sensor control unit 41 does not need to control the light-emitting unit 13. In addition, the distance measurement sensor 81 measures the distance to a subject by the stereo camera system and supplies a result thereof to the arithmetic processing unit 16. The rest are similar to those of the first embodiment described above.

As described above, the distance information acquisition unit 20 of the image pickup apparatus 1 may measure the distance to a subject using the passive-type distance measurement method in addition to the active-type distance measurement method.

Furthermore, the distance information acquisition unit 20 may be a hybrid type including both the active type and the passive type.

The active type can set focus on objects that cannot be focused on in the passive type, such as a white wall, without depending on a texture. Therefore, the distance measurement system of the distance information acquisition unit 20 is favorably an active type or a hybrid type.

Moreover, the distance measurement sensor 81 and the distance measurement sensor 14 are not limited to the examples described above and only need to be sensors capable of measuring distances of two or more points at the same time.

### 4. Configuration Example of Digital Camera

In FIGS. 2 and 15, the arrangement of the distance measurement sensor 14 and the image pickup sensor 15 has been described while taking the case where the image pickup apparatus 1 is constituted of a smartphone as an example.

In descriptions below, the arrangement of the distance measurement sensor 14 and the image pickup sensor 15 in a case where the image pickup apparatus 1 is a single-lens-reflex digital camera or a mirrorless digital camera will be described.

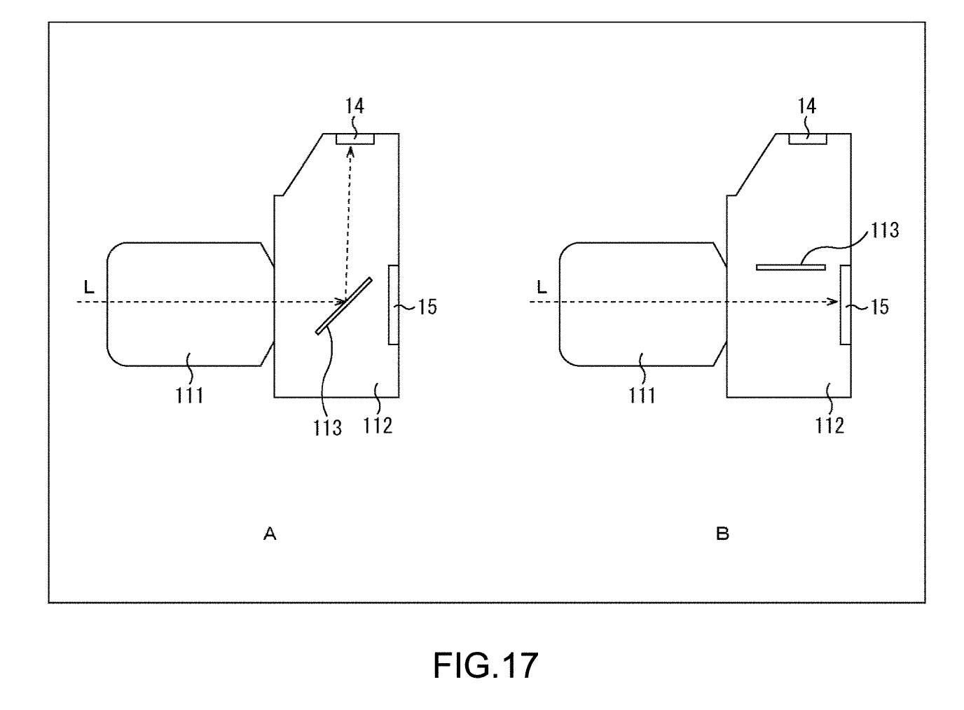

FIG. 17 are cross-sectional diagrams schematically showing a first configuration example in a case where the image pickup apparatus 1 is a mirrorless digital camera.

In FIG. 17, the image pickup apparatus 1 is constituted of a detachable interchangeable lens 111 and a body-side apparatus 112 to which the interchangeable lens 111 is attached, and the distance measurement sensor 14, the image pickup sensor 15, and a movable mirror 113 are provided in the body-side apparatus 112.

The interchangeable lens 111 incorporates therein the focus lens 44, a diaphragm, and the like (not shown) and collects light L from a subject.

The movable mirror 113 is a flat-plate-shaped mirror, and when image pickup by the image pickup sensor 15 is not performed, the movable mirror 113 takes a right-side-up posture as shown in FIG. 17A so as to reflect light that has passed through the interchangeable lens 111 toward an upper portion of the body-side apparatus 112.

Further, when image pickup by the image pickup sensor 15 is performed, the movable mirror 113 takes a horizontal posture as shown in FIG. 17B to cause light that has passed through the interchangeable lens 111 to enter the image pickup sensor 15.

When the shutter button (not shown) is fully pressed, the movable mirror 113 takes the horizontal posture as shown in FIG. 17B, and when the shutter button is not fully pressed, takes the right-side-up posture as shown in FIG. 17A.

The distance measurement sensor 14 is constituted of an image sensor capable of receiving both IR light and visible light, and generates and outputs distance information on the basis of the received IR light.

Further, the distance measurement sensor 14 also serves as an EVF (Electric View Finder) sensor, and by receiving visible light reflected by the movable mirror 113, captures an EVF image to be displayed in an EVF (not shown).

In FIG. 17, in a case where the shutter button is fully pressed, the image pickup sensor 15 receives light from the interchangeable lens 111 and performs image pickup for recording as shown in FIG. 17B.

On the other hand, when the shutter button is not fully pressed, the movable mirror 113 takes the right-side-up posture as shown in FIG. 17A so that light that has passed through the interchangeable lens 111 is reflected by the movable mirror 113 and enters the distance measurement sensor 14 also serving as the EVF sensor. The distance measurement sensor 14 receives the IR light and visible light reflected by the movable mirror 113 to generate and output distance information on the basis of the IR light and also capture an EVF image.

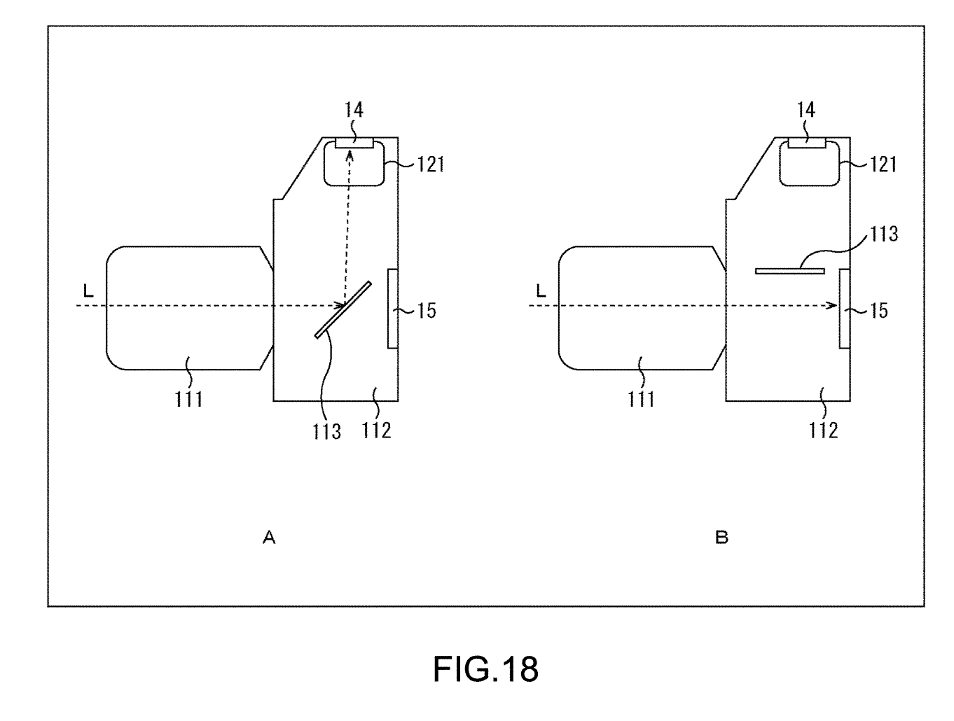

FIG. 18 are cross-sectional diagrams schematically showing a second configuration example in a case where the image pickup apparatus 1 is a mirrorless digital camera.

It should be noted that in the figures, parts corresponding to those of the case shown in FIG. 17 are denoted by the same reference numerals, and descriptions thereof will be omitted as appropriate below.

In FIG. 18, the image pickup apparatus 1 is constituted of the detachable interchangeable lens 111 and the body-side apparatus 112 to which the interchangeable lens 111 is attached, and the distance measurement sensor 14, the image pickup sensor 15, the movable mirror 113, and an EVF optical system 121 are provided in the body-side apparatus 112.

Therefore, the image pickup apparatus 1 shown FIG. 18 is common to that of the case shown in FIG. 17 in the point of including the distance measurement sensor 14, the image pickup sensor 15, and the movable mirror 113 and differs from that of the case shown in FIG. 17 in that the EVF optical system 121 is newly provided.

The EVF optical system 121 is an optical component unique to an EVF sensor, such as an optical filter and a lens, for example, and is provided on a light-incident side of the distance measurement sensor 14 also serving as the EVF sensor. Therefore, the distance measurement sensor 14 receives light that has passed through (travels through) the EVF optical system 121.

When the shutter button (not shown) is fully pressed, the movable mirror 113 takes a horizontal posture as shown in FIG. 18B, and when the shutter button is not fully pressed, takes the right-side-up posture as shown in FIG. 18A.

In a case where the shutter button is fully pressed, the image pickup sensor 15 receives light from the interchangeable lens 111 and performs image pickup for recording as shown in FIG. 18B.

On the other hand, when the shutter button is not fully pressed, the movable mirror 113 takes the right-side-up posture as shown in FIG. 18A, and the distance measurement sensor 14 receives the IR light and visible light reflected by the movable mirror 113, to generate and output distance information on the basis of the IR light and also capture an EVF image.

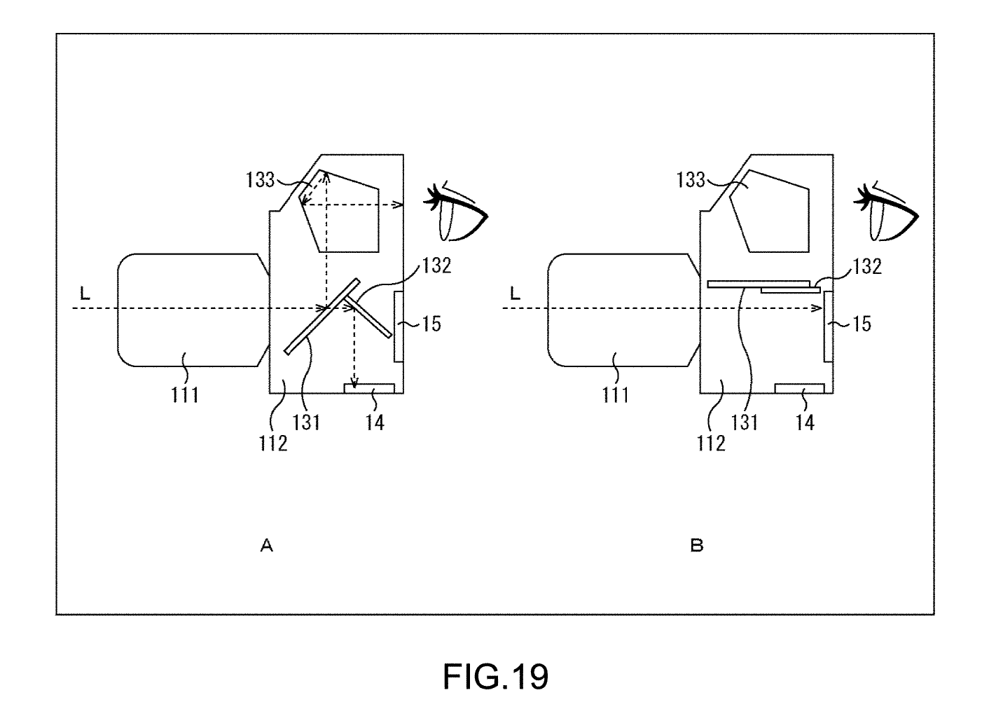

FIG. 19 are cross-sectional diagrams schematically showing a configuration example in the case where the image pickup apparatus 1 is a single-lens-reflex digital camera.

It should be noted that in the figures, parts corresponding to those of the case shown in FIG. 17 are denoted by the same reference numerals, and descriptions thereof will be omitted as appropriate below.

In FIG. 19, the image pickup apparatus 1 is constituted of the detachable interchangeable lens 111 and the body-side apparatus 112 to which the interchangeable lens 111 is attached, and the distance measurement sensor 14, the image pickup sensor 15, a movable half mirror 131, a movable mirror 132, and a pentaprism 133 are provided in the body-side apparatus 112.

Therefore, the image pickup apparatus 1 shown in FIG. 19 is common to that of the case shown in FIG. 17 in the point of including the distance measurement sensor 14, the image pickup sensor 15, and the interchangeable lens 111.

However, the image pickup apparatus 1 shown in FIG. 19 differs from that of the case shown in FIG. 17 in that it does not include the movable mirror 113 and includes the movable half mirror 131, the movable mirror 132, and the pentaprism 133.

The movable half mirror 131 is a flat-plate-shaped mirror that reflects partial light and causes remaining light to pass therethrough, and can be constituted of a mirror to which an optical thin film that transmits IR light and reflects visible light is attached, such as a cold mirror, for example. Alternatively, the movable half mirror 131 can be constituted of a mirror with an optical thin film capable of selecting a wavelength band to be reflected or transmitted like a bandpass filter.

When image pickup by the image pickup sensor 15 is not performed, the movable half mirror 131 takes a right-side-up posture as shown in FIG. 19A so as to reflect a part (visible light) of light that has passed through the interchangeable lens 111 toward the upper portion of the body-side apparatus 112 and also transmit remaining light (IR light).

Further, when the image pickup by the image pickup sensor 15 is performed, the movable half mirror 131 takes a horizontal posture with the movable mirror 132 as shown in FIG. 19B, to thus cause the light that has passed through the interchangeable lens 111 to enter the image pickup sensor 15.

When the shutter button (not shown) is fully pressed, the movable half mirror 131 takes the horizontal posture as shown in FIG. 19B, and when the shutter button is not fully pressed, takes the right-side-up posture as shown in FIG. 19A.

The movable mirror 132 is a flat-plate-shaped mirror, and when image pickup by the image pickup sensor 15 is not performed, the movable mirror 132 takes a left-side-up posture as shown in FIG. 19A so as to reflect light that has passed through the movable half mirror 131 toward a lower portion of the body-side apparatus 112 and cause it to enter the distance measurement sensor 14. The movable mirror 132 may be provided with an optical thin film capable of selecting a wavelength band to reflect like a bandpass filter.

Further, when the image pickup by the image pickup sensor 15 is performed, the movable mirror 132 takes the horizontal posture with the movable half mirror 131 as shown in FIG. 19B to cause light that has passed through the interchangeable lens 111 to enter the image pickup sensor 15.

When the shutter button (not shown) is fully pressed, the movable mirror 132 takes the horizontal posture as shown in FIG. 19B, and when the shutter button is not fully pressed, takes the left-side-up posture as shown in FIG. 19A.

The pentaprism 133 reflects the light reflected by the movable half mirror 131 as appropriate and guides it to a user's eye. The user can check an image (image) captured by the image pickup sensor 15.

In the image pickup apparatus 1 shown FIG. 19, when the shutter button is not fully pressed, the movable half mirror 131 takes the right-side-up posture, and the movable mirror 132 takes the left-side-up posture as shown in FIG. 19A. As a result, the IR light that has passed through the interchangeable lens 111 passes through the movable half mirror 131, and the visible light is reflected by the movable half mirror 131. The visible light reflected by the movable half mirror 131 is further reflected by the pentaprism 133 and enters the user's eye.

On the other hand, the IR light that has passed through the movable half mirror 131 is reflected by the movable mirror 132 and enters the distance measurement sensor 14. The distance measurement sensor 14 receives the IR light reflected by the movable mirror 132, to generate and output distance information on the basis of the IR light.

In the case where the shutter button is fully pressed, the image pickup sensor 15 receives the light from the interchangeable lens 111 and performs image pickup for recording as shown in FIG. 19B.

In the configuration examples shown in FIGS. 17 to 19 where the image pickup apparatus 1 is a single-lens-reflex digital camera or a mirrorless digital camera, the arrangement example of a case where the distance measurement sensor 14 and the image pickup sensor 15 have the same optical axis is shown. However, even in the case of a single-lens-reflex digital camera or a mirrorless digital camera, the distance measurement sensor 14 and the image pickup sensor 15 do not need to have the same optical axis and can be arranged three-dimensionally (can be arranged at different positions in both planar direction and optical axis direction). For example, the distance measurement sensor 14 may be arranged inside a lens barrel, on an outer circumference of the lens barrel, outside a camera casing, or the like, and may be in a different casing as long as it is capable of transmitting and receiving various types of information such as distance information generated by the distance measurement sensor 14 and control information supplied to the distance measurement sensor 14.

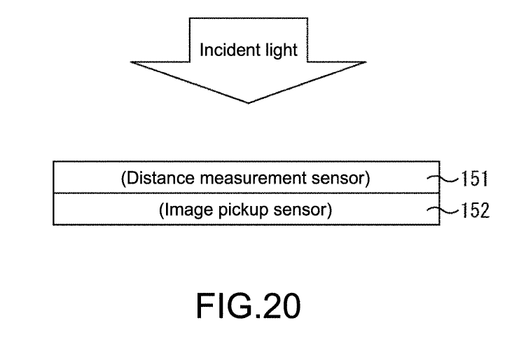

Alternatively, since both the distance measurement sensor 14 and the image pickup sensor 15 can be constituted of an image pickup device, it is possible to form the distance measurement sensor 14 on a first substrate 151 and form the image pickup sensor 15 on a second substrate 152 and laminate the first substrate 151 and the second substrate 152 as shown in FIG. 20. Further, the relationship between the first substrate 151 and the second substrate 152 in the longitudinal direction in the case of laminating them may be a reverse of that shown in FIG. 20.

Furthermore, by forming a photoelectric conversion unit as the image pickup sensor 15 in a single substrate and forming a photoelectric conversion unit that receives IR light on an upper side of the same substrate, the distance measurement sensor 14 and the image pickup sensor 15 can be formed on a single substrate. Similarly, the distance measurement sensor 14 also serving as the EVF sensor can also be realized by forming a photoelectric conversion unit as an EVF sensor on a single substrate and forming a photoelectric conversion unit that receives IR light on the upper side of the same substrate.

### 5. Explanation on Computer to which Present Technology is Applied

The series of processing described above, that is carried out by the control unit 11, the arithmetic processing unit 16, and the like, can be executed by hardware or software. In a case where the series of processing is executed by software, a program configuring the software is installed in a computer such as a microcomputer.

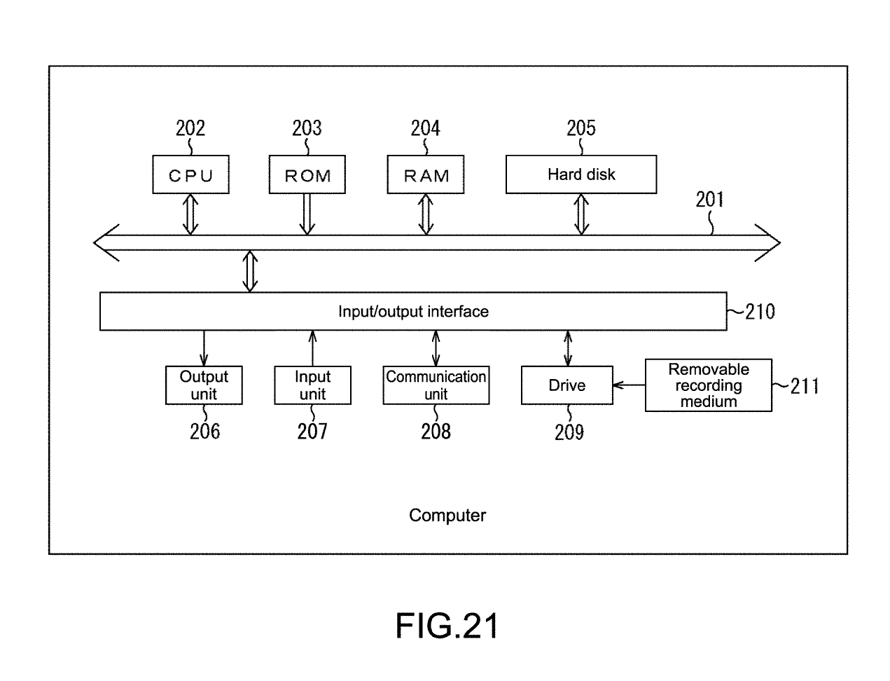

FIG. 21 is a block diagram showing a configuration example of an embodiment of a computer in which a program for executing the series of processing described above is installed.

The program can be prerecorded in a hard disk 205 or a ROM 203 as a built-in recording medium of the computer.

Alternatively, the program can be stored (recorded) in a removable recording medium 211. Such a removable recording medium 211 can be provided as so-called packaged software. Here, examples of the removable recording medium 211 include a flexible disk, a CD-ROM (Compact Disc Read Only Memory), an MO (Magneto Optical) disc, a DVD (Digital Versatile Disc), a magnetic disk, a semiconductor memory, and the like.

It should be noted that in addition to installing the program in a computer from the removable recording medium 211 as described above, the program can be downloaded to a computer via a communication network or a broadcasting network and installed in the built-in hard disk 205. In other words, for example, the program can be wirelessly transferred from a download site to the computer via an artificial satellite for digital satellite broadcasting or wiredly transferred to the computer via a network such as a LAN (Local Area Network) and the Internet.

The computer incorporates therein a CPU (Central Processing Unit) 202, and an input/output interface 210 is connected to the CPU 202 via a bus 201.

When a command is input by the user operating an input unit 207 via the input/output interface 210, the CPU 202 executes the program stored in the ROM (Read Only Memory) 203 accordingly. Alternatively, the CPU 202 loads a program stored in the hard disk 205 into a RAM (Random Access Memory) 204 and executes the program.

Accordingly, the CPU 202 carries out the processing according to the flowcharts described above or the processing carried out by the configuration of the block diagram described above. Then, the CPU 202 outputs the processing result from an output unit 206 or transmits it from a communication unit 208 as necessary via the input/output interface 210, for example, and records it onto the hard disk 205, and the like.

It should be noted that the input unit 207 is constituted of a keyboard, a mouse, a microphone, and the like. Further, the output unit 206 is constituted of an LCD (Liquid Crystal Display), a speaker, and the like.

Here, in this specification, the processing carried out by the computer in accordance with the program does not necessarily need to be carried out in time series in the order described as the flowchart. In other words, the processing carried out by the computer in accordance with the program also includes processing that is executed in parallel or individually (e.g., parallel processing or processing by object).

Further, the program may be processed by a single computer (processor) or may be processed by a plurality of computers in a distributed manner. Furthermore, the program may be transferred to a remote computer and executed.

The present technology is applicable to an image pickup apparatus in general that performs control to drive the focus lens 44 to a predetermined lens position using a motor.

### 6. Application Example

The technology according to the present disclosure is applicable to various products. For example, the technology according to the present disclosure may be realized as an apparatus to be mounted on any type of mobile objects including an automobile, an electric vehicle, a hybrid electric vehicle, a motorcycle, a bicycle, a personal mobility, an airplane, a drone, a ship, a robot, a construction machine, an agricultural machine (tractor), and the like.

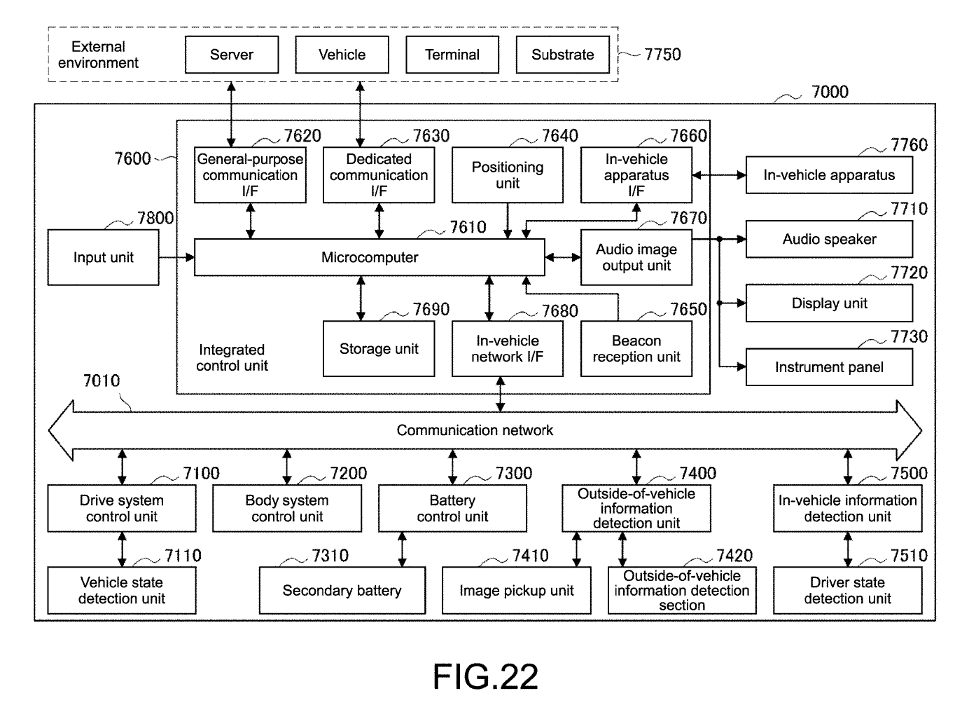

FIG. 22 is a block diagram showing a schematic configuration example of a vehicle control system 7000 which is an example of a mobile object control system to which the technology according to the present disclosure can be applied. The vehicle control system 7000 includes a plurality of electronic control units connected via a communication network 7010. In the example shown in FIG. 22, the vehicle control system 7000 includes a drive system control unit 7100, a body system control unit 7200, a battery control unit 7300, an outside-of-vehicle information detection unit 7400, an in-vehicle information detection unit 7500, and an integrated control unit 7600. The communication network 7010 connecting these plurality of control units may be, for example, an in-vehicle communication network conforming to an arbitrary standard, such as a CAN (Controller Area Network), a LIN (Local Interconnect Network), a LAN (Local Area Network), and FlexRay (registered trademark).

Each of the control units includes a microcomputer that carries out arithmetic processing in accordance with various programs, a storage unit that stores programs to be executed by the microcomputer, parameters to be used for various calculations, and the like, and a drive circuit that drives various control target apparatuses. Each of the control units includes a network I/F for communicating with another control unit via the communication network 7010 and also includes a communication I/F for communicating with apparatuses and sensors in- and outside the vehicle, and the like by wired communication or wireless communication. In FIG. 22, as a functional configuration of the integrated control unit 7600, a microcomputer 7610, a general-purpose communication I/F 7620, a dedicated communication I/F 7630, a positioning unit 7640, a beacon reception unit 7650, an in-vehicle apparatus I/F 7660, an audio image output unit 7670, an in-vehicle network I/F 7680, and a storage unit 7690 are illustrated. Other control units similarly include a microcomputer, a communication I/F, a storage unit, and the like.

The drive system control unit 7100 controls an operation of an apparatus related to a drive system of the vehicle in accordance with various programs. For example, the drive system control unit 7100 functions as a control apparatus for a drive force generation apparatus for generating a drive force of a vehicle, such as an internal combustion engine and a drive motor, a drive force transmission mechanism for transmitting a drive force to wheels, a steering mechanism that adjusts a steering angle of the vehicle, a brake apparatus for generating a brake force of the vehicle, and the like. The drive system control unit 7100 may also include a function as a control apparatus such as ABS (Antilock Brake System) and ESC (Electronic Stability Control).

A vehicle state detection unit 7110 is connected to the drive system control unit 7100. For example, the vehicle state detection unit 7110 includes at least one of a gyro sensor for detecting an angular velocity of an axial rotation movement of a vehicle body, an acceleration sensor for detecting an acceleration of the vehicle, and sensors for detecting an operation amount of an accelerator pedal, an operation amount of a brake pedal, a steering angle of a steering wheel, an RPM of an engine, a rotation speed of the wheels, or the like. The drive system control unit 7100 carries out arithmetic processing using signals input from the vehicle state detection unit 7110 and controls the internal combustion engine, the drive motor, the electric power steering apparatus, the brake apparatus, and the like.

The body system control unit 7200 controls operations of various apparatuses mounted on the vehicle body in accordance with various programs. For example, the body system control unit 7200 functions as a control apparatus for a keyless entry system, a smart key system, a power window apparatus, or various lamps such as headlights, backlights, brake lights, indicators, and fog lamps. In this case, radio waves transmitted from a mobile device that substitutes for a key or signals of various switches can be input to the body system control unit 7200. The body system control unit 7200 receives the input of these radio waves or signals and controls a door lock apparatus, power window apparatus, lamps, and the like of the vehicle.

The battery control unit 7300 controls a secondary battery 7310 which is a power supply source of the drive motor in accordance with various programs. For example, to the battery control unit 7300, information on a battery temperature, a battery output voltage, a remaining battery capacity, and the like is input from a battery apparatus including the secondary battery 7310. The battery control unit 7300 carries out arithmetic processing using these signals and performs temperature adjustment control of the secondary battery 7310 and control of a cooling apparatus or the like provided in the battery apparatus.

The outside-of-vehicle information detection unit 7400 detects external information of the vehicle on which the vehicle control system 7000 is mounted. For example, at least one of an image pickup section 7410 and an outside-of-vehicle information detection section 7420 is connected to the outside-of-vehicle information detection unit 7400. The image pickup section 7410 includes at least one of a ToF (Time Of Flight) camera, a stereo camera, a monocular camera, an infrared camera, and other cameras. The outside-of-vehicle information detection section 7420 includes, for example, at least one of an environmental sensor for detecting a current weather or climate and a peripheral information detection sensor for detecting other vehicles, obstacles, pedestrians, and the like in the periphery of the vehicle on which the vehicle control system 7000 is mounted.

The environmental sensor may be, for example, at least one of a raindrop sensor for detecting rain, a fog sensor for detecting a fog, a sunshine sensor for detecting a sunshine degree, and a snow sensor for detecting a snowfall. The peripheral information detection sensor may be at least one of an ultrasonic sensor, a radar apparatus, and a LIDAR (Light Detection and Ranging, Laser Imaging Detection and Ranging) apparatus. The image pickup section 7410 and the outside-of-vehicle information detection section 7420 may respectively be provided as independent sensors or apparatuses, or may be provided as an apparatus in which a plurality of sensors or apparatuses are integrated.

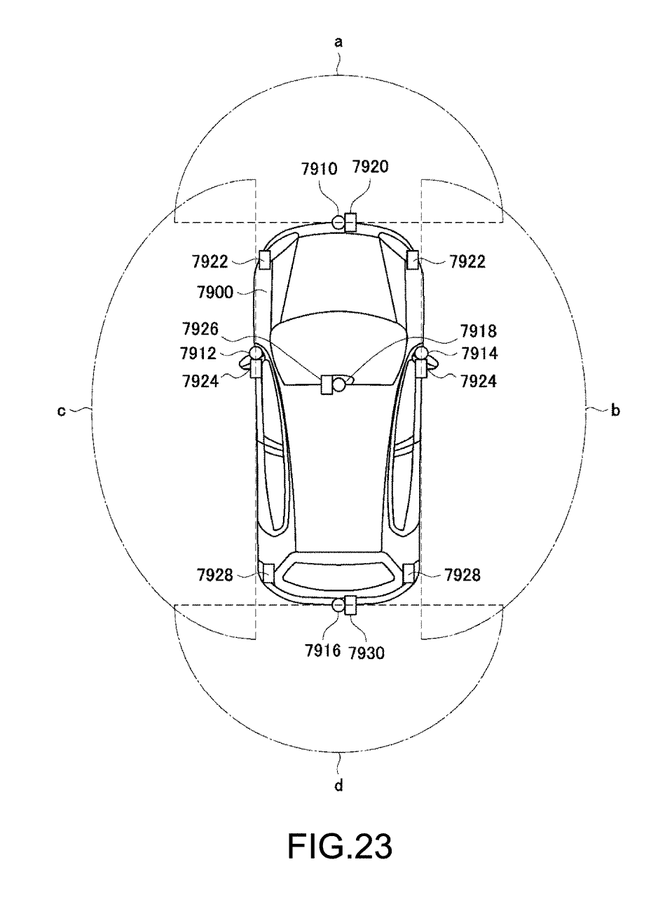

Here, FIG. 23 shows an example of setting positions of the image pickup section 7410 and the outside-of-vehicle information detection section 7420. Image pickup units 7910, 7912, 7914, 7916, and 7918 are positioned at, for example, at least one of a front nose, side mirrors, rear bumper, back door, and upper portion of a front windshield of a vehicle interior of a vehicle 7900. The image pickup unit 7910 provided at the front nose and the image pickup unit 7918 provided at the upper portion of the front windshield of the vehicle interior mainly acquire images in front of the vehicle 7900. The image pickup units 7912 and 7914 provided at the side mirrors mainly acquire side images of the vehicle 7900. The image pickup unit 7916 provided at the rear bumper or the back door mainly acquires an image behind the vehicle 7900. The image pickup unit 7918 provided at the upper portion of the front windshield of the vehicle interior is mainly used for detecting preceding vehicles, pedestrians, obstacles, traffic lights, traffic signs, lanes, and the like.

It should be noted that FIG. 23 shows an example of photographing ranges of the image pickup units 7910, 7912, 7914, and 7916, respectively. The image pickup range a indicates an image pickup range of the image pickup unit 7910 provided at the front nose, the image pickup ranges b and c respectively indicate image pickup ranges of the image pickup units 7912 and 7914 provided at the side mirrors, and the image pickup range d indicates an image pickup range of the image pickup unit 7916 provided at the rear bumper or the back door. For example, by superimposing image data captured by the image pickup units 7910, 7912, 7914, and 7916, an overhead view image of the vehicle 7900 viewed from above can be obtained.

Outside-of-vehicle information detection sections 7920, 7922, 7924, 7926, 7928, 7930 provided at the front, rear, sides, corners, and upper portion of the front windshield of the vehicle interior of the vehicle 7900 may be ultrasonic sensors or radar apparatuses, for example. The outside-of-vehicle information detection sections 7920, 7926, and 7930 provided at the front nose, rear bumper, back door, and upper portion of the front windshield of the vehicle interior of the vehicle 7900 may be, for example, LIDAR apparatuses. These outside-of-vehicle information detection sections 7920 to 7930 are mainly used for detecting preceding vehicles, pedestrians, obstacles, and the like.

Returning to FIG. 22, the descriptions will be continued. The outside-of-vehicle information detection unit 7400 causes the image pickup unit 7410 to capture an image of an outside of the vehicle and receives captured image data. Further, the outside-of-vehicle information detection unit 7400 receives detection information from the connected outside-of-vehicle information detection section 7420. In a case where the outside-of-vehicle information detection section 7420 is an ultrasonic sensor, a radar apparatus, or a LIDAR apparatus, the outside-of-vehicle information detection unit 7400 transmits ultrasonic waves, electromagnetic waves, or the like and receives information of the received reflected waves. The outside-of-vehicle information detection unit 7400 may carry out object detection processing or distance detection processing of a person, car, obstacle, sign, characters on a road surface, and the like, on the basis of the received information. The outside-of-vehicle information detection unit 7400 may also carry out environment recognition processing for recognizing a rainfall, fog, road surface condition, and the like on the basis of the received information. The outside-of-vehicle information detection unit 7400 may also calculate a distance to an object outside the vehicle on the basis of the received information.

Furthermore, the outside-of-vehicle information detection unit 7400 may also carry out image recognition processing for recognizing a person, car, obstacle, sign, characters on a road surface, and the like or distance detection processing on the basis of the received image data. The outside-of-vehicle information detection unit 7400 may also carry out processing of a distortion correction, positioning, or the like on the received image data, and synthesize the image data captured by the different image pickup units 7410 to generate an overhead view image or panorama image. The outside-of-vehicle information detection unit 7400 may also carry out viewpoint conversion processing using image data captured by the different image capturing units 7410.

The in-vehicle information detection unit 7500 detects in-vehicle information. Connected to the in-vehicle information detection unit 7500 is, for example, a driver state detection unit 7510 that detects a state of a driver. The driver state detection unit 7510 may include a camera for capturing the driver, a biological sensor for detecting biological information of the driver, a microphone for collecting audio in the vehicle interior, and the like. The biological sensor is provided in, for example, a seat, a steering wheel, or the like, and detects biological information of a passenger sitting on the seat or the driver holding the steering wheel. The in-vehicle information detection unit 7500 may calculate a degree of fatigue or a degree of concentration of the driver or judge whether the driver is falling asleep on the basis of the detection information input from the driver state detection unit 7510. The in-vehicle information detection unit 7500 may also carry out noise canceling processing on collected audio signals, and the like.

The integrated control unit 7600 controls overall operations of the vehicle control system 7000 in accordance with various programs. An input unit 7800 is connected to the integrated control unit 7600. The input unit 7800 is realized by an apparatus to which a passenger can perform an input operation, such as a touch panel, a button, a microphone, a switch, and a lever. Data obtained by carrying out audio recognition on audio input via the microphone may be input to the integrated control unit 7600. The input unit 7800 may be, for example, a remote control apparatus that uses infrared rays or other radio waves, or an externally-connected apparatus such as a cellular phone and a PDA (Personal Digital Assistant) that correspond to operations of the vehicle control system 7000. The input unit 7800 may be, for example, a camera, and in this case, the passenger can input information by gestures. Alternatively, data obtained by detecting a movement of a wearable apparatus worn by the passenger may be input. Further, the input unit 7800 may include, for example, an input control circuit that generates an input signal on the basis of information input by the passenger or the like using the input unit 7800 described above and outputs the input signal to the integrated control unit 7600, or the like. By operating this input unit 7800, the passenger or the like inputs various types of data or instructs a processing operation with respect to the vehicle control system 7000.

The storage unit 7690 may include a ROM (Read Only Memory) that stores various programs to be executed by the microcomputer and a RAM (Random Access Memory) that stores various parameters, calculation results, sensor values, and the like. Further, the storage unit 7690 may be realized by a magnetic storage device such as an HDD (Hard Disk Drive), a semiconductor storage device, an optical storage device, a magneto-optical storage device, or the like.

The general-purpose communication I/F 7620 is a general-purpose communication I/F that mediates communication among various apparatuses existing in an external environment 7750. In the general-purpose communication I/F 7620, a cellular communication protocol such as GSM (Global System of Mobile communications), WiMAX, LTE (Long Term Evolution), and LTE-A (LTE-Advanced) or other wireless communication protocols such as a wireless LAN (also referred to as Wi-Fi (registered trademark)) and Bluetooth (registered trademark) may be implemented. The general-purpose communication I/F 7620 may be connected to an apparatus (e.g., application server or control server) existing in an external network (e.g., Internet, cloud network, or network unique to business operator) via a base station or an access point, for example. Further, the general-purpose communication I/F 7620 may use, for example, a P2P (Peer To Peer) technology to be connected with a terminal existing in the vicinity of the vehicle (e.g., terminal of driver, pedestrian or shop, or MTC (Machine Type Communication) terminal).

The dedicated communication I/F 7630 is a communication I/F that supports a communication protocol formulated for use in a vehicle. For example, in the dedicated communication I/F 7630, WAVE (Wireless Access in Vehicle Environment) as a combination of lower-layer IEEE 802.11p and upper-layer IEEE 1609, DSRC (Dedicated Short Range Communications), or a standard protocol such as a cellular communication protocol can be implemented. Typically, the dedicated communication I/F 7630 executes V2X communication as a general idea including one or more of vehicle to vehicle (Vehicle to Vehicle) communication, vehicle to infrastructure (Vehicle to Infrastructure) communication, vehicle to home (Vehicle to Home) communication, and vehicle to pedestrian (Vehicle to Pedestrian) Communication.

The positioning unit 7640 receives a GNSS signal (e.g., GPS signal from GPS (Global Positioning System) satellite) from a GNSS (Global Navigation Satellite System) satellite to execute positioning, for example, and generates positional information including a latitude, longitude, and altitude of the vehicle. It should be noted that the positioning unit 7640 may specify a current position by exchanging signals with a wireless access point, or may acquire positional information from a terminal such as a cellular phone, a PHS, and a smartphone including a positioning function.

The beacon reception unit 7650 receives radio waves or electromagnetic waves transmitted from a radio station or the like set on a road, for example, and acquires information on the current position, traffic jam, road closure, required time, and the like. It should be noted that the function of the beacon reception unit 7650 may be included in the dedicated communication I/F 7630 described above.

The in-vehicle apparatus I/F 7660 is a communication interface that mediates connections between the microcomputer 7610 and various in-vehicle apparatuses 7760 existing in the vehicle. The in-vehicle apparatus I/F 7660 may establish a wireless connection using a wireless communication protocol such as wireless LAN, Bluetooth (registered trademark), NFC (Near Field Communication), and WUSB (Wireless USB). Further, the in-vehicle apparatus I/F 7660 may establish a wired connection using a USB (Universal Serial Bus), HDMI (High-Definition Multimedia Interface), and MHL (Mobile High-definition Link) via a connection terminal (not shown) (and cable if necessary). An in-vehicle apparatus 7760 may include, for example, at least one of a mobile apparatus or a wearable apparatus possessed by the passenger, and an information apparatus carried into or attached to the vehicle. Furthermore, the in-vehicle apparatus 7760 may include a navigation apparatus that performs a route search to an arbitrary destination. The in-vehicle apparatus I/F 7660 exchanges control signals or data signals with these in-vehicle apparatuses 7760.

The in-vehicle network I/F 7680 is an interface that mediates communication between the microcomputer 7610 and the communication network 7010. The in-vehicle network I/F 7680 exchanges signals and the like in accordance with a predetermined protocol supported by the communication network 7010.

The microcomputer 7610 of the integrated control unit 7600 controls the vehicle control system 7000 in accordance with various programs on the basis of information acquired via at least one of the general-purpose communication I/F 7620, the dedicated communication I/F 7630, the positioning unit 7640, the beacon reception unit 7650, the in-vehicle apparatus I/F 7660, and the in-vehicle network I/F 7680. For example, the microcomputer 7610 may calculate a control target value of the drive force generation apparatus, the steering mechanism, or the brake apparatus on the basis of acquired information on the inside and outside of the vehicle, and output a control command to the drive system control unit 7100. For example, the microcomputer 7610 may perform cooperative control that aims at realizing a function of ADAS (Advanced Driver Assistance System) that includes collision avoidance or impact mitigation of the vehicle, follow-up traveling based on an inter-vehicle distance, vehicle-speed maintenance traveling, vehicle collision warning, lane deviation warning of the vehicle, and the like. Further, the microcomputer 7610 may control the drive force generation apparatus, the steering mechanism, the brake apparatus, or the like on the basis of acquired peripheral information of the vehicle, to thus perform cooperative control that aims at realizing automated drive in which a vehicle runs autonomously without depending on operations of a driver, and the like.

The microcomputer 7610 may generate three-dimensional distance information between the vehicle and objects such as peripheral structures and people on the basis of information acquired via at least one of the general-purpose communication I/F 7620, the dedicated communication I/F 7630, the positioning unit 7640, the beacon reception unit 7650, the in-vehicle apparatus I/F 7660, and the in-vehicle network I/F 7680, and create local map information including peripheral information regarding the current position of the vehicle. Further, the microcomputer 7610 may predict a danger such as a collision of a vehicle, approach of a pedestrian or the like, and entry into a closed road on the basis of the acquired information, and generate a warning signal. The warning signal may be, for example, a signal for generating a warning sound or a signal for turning on a warning lamp.

The audio image output unit 7670 transmits an output signal of at least one of audio and an image to an output apparatus capable of visually or auditorily notifying the passenger of the vehicle or the outside of the vehicle of the information. In the example shown in FIG. 22, an audio speaker 7710, a display unit 7720, and an instrument panel 7730 are exemplified as the output apparatus. The display unit 7720 may include at least one of an on-board display and a head-up display, for example. The display unit 7720 may include an AR (Augmented Reality) display function. Other than these apparatuses, the output apparatus may be a wearable device such as a headphone and a glasses-type display worn by the passenger, or other apparatuses such as a projector and a lamp. In a case where the output apparatus is a display apparatus, the display apparatus visually displays results obtained by the various types of processing carried out by the microcomputer 7610 or information received from other control units in various forms such as a text, an image, a table, and a graph. In a case where the output apparatus is an audio output apparatus, the audio output apparatus converts audio signals constituted of reproduced audio data, acoustic data, or the like into analog signals, and auditorily outputs the signals.

It should be noted that in the example shown in FIG. 22, at least two control units connected via the communication network 7010 may be integrated as one control unit. Alternatively, each of the control units may be constituted of a plurality of control units. In addition, the vehicle control system 7000 may include another control unit not shown. Further, in the descriptions above, a part or all of the functions provided to any of the control units may be given to another control unit. In other words, as long as information can be transmitted and received via the communication network 7010, predetermined arithmetic processing may be carried out by any control unit. Similarly, a sensor or apparatus connected to any one of the control units may be connected to another control unit, and the plurality of control units may transmit and receive detection information to/from each another via the communication network 7010.

It should be noted that a computer program for realizing the respective functions of the image pickup apparatus 1 according to the respective embodiments described with reference to FIG. 1 and the like can be mounted on any of the control units or the like. Further, it is also possible to provide a computer readable recording medium that stores such a computer program. The recording medium is, for example, a magnetic disk, an optical disc, a magneto-optical disc, a flash memory, or the like. Further, the computer program described above may be distributed via, for example, a network without using the recording medium.

In the vehicle control system 7000 described above shown in FIG. 22, the image pickup sensor 15 and the distance information acquisition unit 20 of the image pickup apparatus 1 according to the respective embodiments described with reference to FIG. 1 and the like correspond to the image pickup unit 7410 and the outside-of-vehicle information detection section 7420. Moreover, the control unit 11 and the arithmetic processing unit 16 of the image pickup apparatus 1 correspond to the microcomputer 7610 of the integrated control unit 7600, and the storage unit 17 and the display unit 18 of the image pickup apparatus 1 respectively correspond to the storage unit 7690 of the integrated control unit 7600 and the display unit 7720. For example, the storage unit 7690 stores a LUT that stores a correspondence relationship between distance information with respect to a subject and a lens control value, and the microcomputer 7610 can perform LUT focus control for controlling an optical system of the image pickup unit 7410 on the basis of distance information calculated from an image captured by the image pickup unit 7410. By applying the technology according to the present disclosure to the vehicle control system 7000, focus control of the image pickup unit 7410 can be performed without depending on environmental conditions and optical conditions, for example.

Further, at least a part of the constituent elements of the image pickup apparatus 1 described with reference to FIG. 1 and the like may be realized in a module for the integrated control unit 7600 shown in FIG. 22 (e.g., integrated circuit module constituted of one die). Alternatively, the image pickup apparatus 1 described with reference to FIG. 1 and the like may be realized by the plurality of control units of the vehicle control system 7000 shown in FIG. 22.

Embodiments of the present technology are not limited to the embodiments described above and can be variously modified without departing from the gist of the present technology.

In each of the embodiments described above, a part of the control performed by the sensor control unit 41 may be performed by the lens control unit 42, or on the contrary, a part of the control performed by the lens control unit 42 may be performed by the sensor control unit 41.

It is possible to adopt a configuration in which all or parts of the plurality of embodiments described above are combined.

For example, in the present technology, it is possible to adopt a cloud computing configuration in which one function is shared by and processed cooperatively by a plurality of apparatuses via a network.

Further, the respective steps described in the flowcharts described above can be shared and executed by a plurality of apparatuses in addition to executing them by a single apparatus.

Furthermore, in a case where a plurality of processing are included in a single step, the plurality of processing included in the single step can be shared and executed by a plurality of apparatuses in addition to executing them by a single apparatus.

It should be noted that the effects described in the present specification are mere examples and should not be limited, and effects other than those described in the present specification may also be obtained.

It should be noted that the present technology can also take the following configurations.

(1) An image pickup apparatus, including:

an image pickup device having a predetermined image pickup area;

a lens drive unit that drives a focus lens;

a storage unit that stores, in a lookup table, a correspondence relationship between distance information with respect to a subject and lens position information of the focus lens;

a distance information acquisition unit that acquires distance information with respect to an object existing in the image pickup area; and

a control unit that controls the lens drive unit on the basis of the distance information acquired by the distance information acquisition unit and the lookup table.

(2) The image pickup apparatus according to (1), in which

the control unit further controls a shutter operation on the basis of the distance information acquired by the distance information acquisition unit.

(3) The image pickup apparatus according to (2), in which

the control unit causes the shutter operation to be performed in a case where the distance with respect to the object falls within a predetermined distance range.

(4) The image pickup apparatus according to any one of (1) to (3), in which

the lens position information of the focus lens is a lens control value supplied to the lens drive unit.

(5) The image pickup apparatus according to any one of (1) to (4), in which

the distance information acquisition unit is provided at a different position from the image pickup device.

(6) The image pickup apparatus according to any one of (1) to (5), in which

the distance information acquisition unit includes a light-emitting unit that emits light and a light reception unit that receives the light, and

the distance information with respect to the object is acquired on the basis of an elapsed time up to when the light emitted from the light-emitting unit and reflected by the object is received.

(7) The image pickup apparatus according to (6), in which

a framerate at which the light reception unit receives light is equal to or larger than a framerate of the image pickup device.

(8) The image pickup apparatus according to (6) or (7), in which

the light reception unit is provided while being layered with the image pickup device.

(9) The image pickup apparatus according to any one of (6) to (8), in which

the light-emitting unit emits infrared light.

(10) The image pickup apparatus according to any one of (1) to (4), in which

the distance information acquisition unit includes two image pickup devices that are arranged while being set apart a predetermined interval.

(11) The image pickup apparatus according to any one of (1) to (10), in which

the control unit repetitively executes, at predetermined time intervals, the control of the lens drive unit based on the distance information acquired by the distance information acquisition unit and the lookup table.

(12) The image pickup apparatus according to any one of (1) to (11), further including

an operation unit that receives a user operation,

in which

the storage unit stores a plurality of lookup tables, and

the control unit controls the lens drive unit using the lookup table selected from the plurality of lookup tables stored in the storage unit on the basis of the user operation.

(13) The image pickup apparatus according to any one of (1) to (12), in which

the image pickup apparatus is an interchangeable-lens-type image pickup apparatus,

the storage unit stores a plurality of lookup tables, and

the control unit controls the lens drive unit using the lookup table corresponding to the attached focus lens out of the plurality of lookup tables.

(14) The image pickup apparatus according to any one of (1) to (13), further including

an operation unit that receives an input of the distance information by a user,

in which

the control unit creates the lookup table on the basis of the distance information input by the user and causes the storage unit to store the lookup table.

(15) The image pickup apparatus according to any one of (1) to (14), further including

a communication unit that communicates predetermined data with an external apparatus,

in which

the control unit controls the lens drive unit using the lookup table acquired via the communication unit.

(16) The image pickup apparatus according to any one of (1) to (15), in which

the control unit further performs control to cause a depth map to be displayed on a display unit on the basis of the distance information acquired by the distance information acquisition unit.

(17) An image pickup control method carried out by an image pickup apparatus including an image pickup device including a predetermined image pickup area, a lens drive unit that drives a focus lens, and a storage unit that stores, by a lookup table, a correspondence relationship between distance information with respect to a subject and lens position information of the focus lens, the method including:

acquiring distance information with respect to an object existing in the image pickup area; and

controlling the lens drive unit on the basis of the acquired distance information and the lookup table.

(18) A program that causes a computer of an image pickup apparatus including an image pickup device including a predetermined image pickup area and a storage unit that stores, by a lookup table, a correspondence relationship between distance information with respect to a subject and lens position information of a focus lens, to execute processing including:

acquiring distance information with respect to an object existing in the image pickup area; and

controlling a lens position of the focus lens on the basis of the acquired distance information and the lookup table.

(19) An image pickup apparatus, including:

an image pickup device including a predetermined image pickup area;

a lens drive unit that drives a focus lens;

a storage unit that stores, by a lookup table, a correspondence relationship between distance information with respect to a subject and lens position information of the focus lens;

a lens position control unit that controls the lens drive unit on the basis of the lookup table;

a distance information acquisition unit that acquires distance information with respect to an object existing in the image pickup area; and

an image pickup control unit that executes control related to image pickup on the basis of the distance information acquired by the distance information acquisition unit.

### REFERENCE SIGNS LIST

1 image pickup apparatus
11 control unit
12 optical system
13 light-emitting unit
14 distance measurement sensor
15 image pickup sensor
16 arithmetic processing unit
17 storage unit
18 display unit
19 operation unit
20 distance information acquisition unit
21 communication unit
41 sensor control unit
42 lens control unit
43 lens drive unit
44 focus lens
81 distance measurement sensor
82A first image pickup device
82B second image pickup device
202 CPU
203 ROM
204 RAM
205 hard disk
206 output unit
207 input unit
208 communication unit
209 drive

1. An image pickup apparatus, comprising:
an image pickup device having a predetermined image pickup area;
a lens drive unit that drives a focus lens;
a storage unit that stores, in a lookup table, a correspondence relationship between distance information with respect to a subject and lens position information of the focus lens;
a distance information acquisition unit that acquires distance information with respect to an object existing in the image pickup area; and
a control unit that controls the lens drive unit on the basis of the distance information acquired by the distance information acquisition unit and the lookup table.

2. The image pickup apparatus according to claim 1, wherein
the control unit further controls a shutter operation on the basis of the distance information acquired by the distance information acquisition unit.

3. The image pickup apparatus according to claim 2, wherein
the control unit causes the shutter operation to be performed in a case where the distance with respect to the object falls within a predetermined distance range.

4. The image pickup apparatus according to claim 1, wherein
the lens position information of the focus lens is a lens control value supplied to the lens drive unit.

5. The image pickup apparatus according to claim 1, wherein
the distance information acquisition unit is provided at a different position from the image pickup device.

6. The image pickup apparatus according to claim 1, wherein
the distance information acquisition unit includes a light-emitting unit that emits light and a light reception unit that receives the light, and
the distance information with respect to the object is acquired on the basis of an elapsed time up to when the light emitted from the light-emitting unit and reflected by the object is received.

7. The image pickup apparatus according to claim 6, wherein
a framerate at which the light reception unit receives light is equal to or larger than a framerate of the image pickup device.

8. The image pickup apparatus according to claim 6, wherein
the light reception unit is provided while being layered with the image pickup device.

9. The image pickup apparatus according to claim 6, wherein
the light-emitting unit emits infrared light.

10. The image pickup apparatus according to claim 1, wherein
the distance information acquisition unit includes two image pickup devices that are arranged while being set apart a predetermined interval.

11. The image pickup apparatus according to claim 1, wherein
the control unit repetitively executes, at predetermined time intervals, the control of the lens drive unit based on the distance information acquired by the distance information acquisition unit and the lookup table.

12. The image pickup apparatus according to claim 1, further comprising
an operation unit that receives a user operation,
wherein
the storage unit stores a plurality of lookup tables, and
the control unit controls the lens drive unit using the lookup table selected from the plurality of lookup tables stored in the storage unit on the basis of the user operation.

13. The image pickup apparatus according to claim 1, wherein
the image pickup apparatus is an interchangeable-lens-type image pickup apparatus,
the storage unit stores a plurality of lookup tables, and
the control unit controls the lens drive unit using the lookup table corresponding to the attached focus lens out of the plurality of lookup tables.

14. The image pickup apparatus according to claim 1, further comprising
an operation unit that receives an input of the distance information by a user,
wherein
the control unit creates the lookup table on the basis of the distance information input by the user and causes the storage unit to store the lookup table.

15. The image pickup apparatus according to claim 1, further comprising
a communication unit that communicates predetermined data with an external apparatus,
wherein
the control unit controls the lens drive unit using the lookup table acquired via the communication unit.

16. The image pickup apparatus according to claim 1, wherein
the control unit further performs control to cause a depth map to be displayed on a display unit on the basis of the distance information acquired by the distance information acquisition unit.

17. An image pickup control method carried out by an image pickup apparatus including an image pickup device having a predetermined image pickup area, a lens drive unit that drives a focus lens, and a storage unit that stores, in a lookup table, a correspondence relationship between distance information with respect to a subject and lens position information of the focus lens, the method comprising:
acquiring distance information with respect to an object existing in the image pickup area; and
controlling the lens drive unit on the basis of the acquired distance information and the lookup table.

18. A program that causes a computer of an image pickup apparatus including an image pickup device having a predetermined image pickup area and a storage unit that stores, in a lookup table, a correspondence relationship between distance information with respect to a subject and lens position information of a focus lens, to execute processing including:
acquiring distance information with respect to an object existing in the image pickup area; and
controlling a lens position of the focus lens on the basis of the acquired distance information and the lookup table.

19. An image pickup apparatus, comprising:
an image pickup device having a predetermined image pickup area;
a lens drive unit that drives a focus lens;
a storage unit that stores, in a lookup table, a correspondence relationship between distance information with respect to a subject and lens position information of the focus lens;
a lens position control unit that controls the lens drive unit on the basis of the lookup table;
a distance information acquisition unit that acquires distance information with respect to an object existing in the image pickup area; and
an image pickup control unit that executes control related to image pickup on the basis of the distance information acquired by the distance information acquisition unit.
